(19) United States
(12) Patent Application Publication
(10) Pub. No.: US 2024/0380549 A1
(43) Pub. Date: Nov. 14, 2024

(54) Port Mapping Method for Sounding Reference Signal, and Terminal

(71) Applicant: VIVO MOBILE COMMUNICATION CO., LTD., Dongguan (CN)

(72) Inventors: Kaili Zheng, Dongguan (CN); Yuan Shi, Dongguan (CN); Rakesh Tamrakar, Dongguan (CN)

(21) Appl. No.: 18/764,719

(22) Filed: Jul. 5, 2024

Related U.S. Application Data
(63) Continuation of application No. PCT/CN2023/071093, filed on Jan. 6, 2023.

(30) Foreign Application Priority Data
Jan. 7, 2022 (CN) 202210016659.0

(51) Int. Cl. H04L 5/00; H04L 27/26

(52) U.S. Cl. CPC H04L 5/0051; H04L 27/2605; H04L 27/2613

(57) ABSTRACT

A port mapping method for sounding reference signals includes in a case that a number of ports for a first SRS is 6 or 8, determining, by a terminal, a CS corresponding to each port for the first SRS and/or a comb position mapped by the each port for the first SRS; where a comb structure size of the first SRS is N, and N is 2, 4, 6, or 8.

### CROSS-REFERENCE TO RELATED APPLICATIONS

This application is a Bypass Continuation application of International Patent Application No. PCT/CN2023/071093 filed Jan. 6, 2023, and claims priority to Chinese Patent Application No. 202210016659.0 filed Jan. 7, 2022, the disclosures of which are hereby incorporated by reference in their entireties.

### BACKGROUND OF THE INVENTION

### Field of the Invention

This application pertains to the field of communications technologies, and in particular, relates to a port mapping method for sounding reference signals and a terminal.

### Description of Related Art

In an NR system, sounding reference signals (SRS) can be used for beam management, codebook-based transmission, non-codebook-based transmission, and antenna switching transmission. A terminal can obtain a plurality of SRS resource sets through higher-layer signaling, and configuration for each SRS resource set includes configurations of its usage, periodic characteristics, or the like.

In Release-15/16, SRS resources can occupy the last 6 symbols in one slot, and configuration can be made through higher-layer signaling to occupy 1/2/4 symbol for SRS transmission, and supports a comb-like structure such as comb-2 and comb-4 in frequency domain. Release-17 is enhanced on the basis of Release-15/16. In one slot, a starting symbol position of SRS resources may be any symbol in one slot. A comb-8 structure is also supported.

### SUMMARY OF THE INVENTION

According to a first aspect, a port mapping method for sounding reference signals is provided, where the method includes:
in a case that the number of ports for a first sounding reference signal SRS is 6 or 8, determining, by a terminal, a cyclic shift CS corresponding to each port for the first SRS and/or a comb position mapped by the each port for the first SRS; where
a comb structure size of the first SRS is N, and N is 2, 4, 6, or 8.

According to a second aspect, a port mapping apparatus for sounding reference signals is provided, including: a first determining unit, configured to: in a case that the number of ports for a first sounding reference signal SRS is 6 or 8, determine, for a terminal, a cyclic shift CS corresponding to each port for the first SRS and/or a comb position mapped by the each port for the first SRS; where
a comb structure size of the first SRS is N, and N is 2, 4, 6, or 8.

According to a third aspect, a terminal is provided, where the terminal includes a processor and a memory, and a program or instructions executable on the processor are stored in the memory. When the program or the instructions are executed by the processor, the steps of the method according to the first aspect are implemented.

According to a fourth aspect, a terminal is provided, including a processor and a communication interface, where the processor is configured to: in a case that the number of ports for a first sounding reference signal SRS is 6 or 8, determine a cyclic shift CS corresponding to each port for the first SRS and/or a comb position mapped by the each port for the first SRS; where a comb structure size of the first SRS is N, and N is 2, 4, 6, or 8.

According to a fifth aspect, a non-transitory readable storage medium is provided, where a program or instructions are stored in the non-transitory readable storage medium, and when the program or the instructions are executed by a processor, the steps of the method according to the first aspect are implemented.

According to a sixth aspect, a chip is provided, where the chip includes a processor and a communication interface, the communication interface is coupled to the processor, and the processor is configured to run a program or instructions to implement the method according to the first aspect.

According to a seventh aspect, a computer program/program product is provided, where the computer program/program product is stored in a non-transitory storage medium, and the computer program/program product is executed by at least one processor to implement the steps of the port mapping method for sounding reference signals according to the first aspect.

### BRIEF DESCRIPTION OF THE DRAWINGS

FIG. 1 is a block diagram of a wireless communications system to which the embodiments of this application are applicable;

FIG. 2 is a schematic flowchart of a port mapping method for sounding reference signals according to an embodiment of this application;

FIG. 3 is a schematic structural diagram of a port mapping apparatus for sounding reference signals according to an embodiment of this application;

FIG. 4 is a schematic structural diagram of a communication device according to an embodiment of this application; and

FIG. 5 is a schematic diagram of a hardware structure of a terminal for implementing the embodiments of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate an order or sequence. It should be understood that the terms used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the associated objects are in an “or” relationship.

It should be noted that technologies described in the embodiments of this application are not limited to a long term evolution (LTE)/LTE-advanced (LTE-A) system, and may also be used in various wireless communications systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a new radio (NR) system is described for an illustration purpose, and NR terms are used in most of the following descriptions, although these technologies may also be applied to other applications than an NR system application, for example, the 6th generation (6G) communications system.

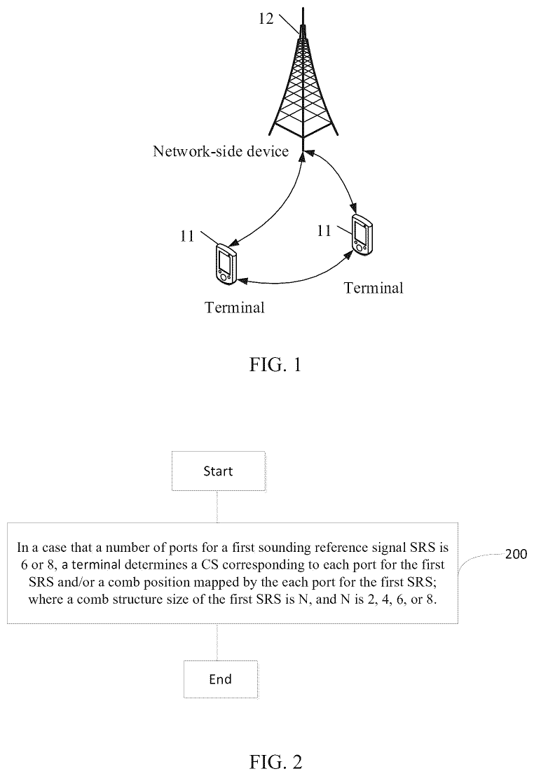

FIG. 1 is a block diagram of a wireless communications system to which the embodiments of this application are applicable. The wireless communications system includes a terminal 11 and a network-side device 12. The terminal 11 may be a terminal-side device, such as a mobile phone, a tablet computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, or the like. It should be noted that a type of the terminal 11 is not limited in the embodiments of this application. The network-side device 12 may include an access network device or a core network device, where the access network device 12 may also be referred to as a radio access network device, a radio access network (RAN), a radio access network function, or a radio access network unit. The access network device 12 may include a base station, a WLAN access point a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a WLAN access point, a Wi-Fi node, a transmission and reception point (TRP), or another appropriate term in the art. Provided that a same technical effect is achieved, the base station is not limited to a technical term. It should be noted that in the embodiments of this application, the base station in the NR system is merely used as an example, and a type of the base station is not limited. The core network device may include but is not limited to at least one of the following: a core network node, a core network function, a mobility management entity (MME), an access mobility management function (AMF), a session management function (SMF), a user plane function (UPF), a policy control function (PCF), a policy and charging rules function (PCRF), an edge application service discovery function (EASDF), a unified data management (UDM), a unified data repository (UDR), a home subscriber server (HSS), a centralized network configuration (CNC), a network storage function (NRF), a network exposure function (NEF), a local NEF (L-NEF), a binding support function (BSF), an application Function (AF), or the like. It should be noted that, in the embodiments of this application, a core network device in an NR system is used as an example for description, and a type of the core network device is not limited.

The existing NR protocol supports only the number of SRS ports being 1, 2, and 4. To improve the performance of uplink transmission, it is necessary to support a larger quantity of SRS ports, for example, the number of SRS ports is 6 and 8. Because orthogonality between different SRS ports needs to be guaranteed as much as possible, existing SRS port mapping modes cannot be fully applied to a case with the number of SRS ports being 6 and 8.

The following describes in detail a port mapping method for sounding reference signals provided in the embodiments of this application by using some embodiments and application scenarios thereof with reference to the accompanying drawings.

FIG. 2 is a schematic flowchart of a port mapping method for sounding reference signals according to an embodiment of this application. As shown in FIG. 2, the method includes:

Step 200: In a case that the number of ports for a first sounding reference signal SRS is 6 or 8, a terminal determines a cyclic shift (CS) corresponding to the each port for the first SRS and/or a comb position mapped by the each port for the first SRS; where
a comb structure size of the first SRS is N, and N is 2, 4, 6, or 8.

It should be noted that the comb position can be understood as a subcarrier position mapped by an SRS in frequency domain.

This embodiment of this application provides a port mapping solution used for cases that different combs are configured for SRSs when the number of ports for SRSs is 6 and 8, which can improve the orthogonality of SRS reference signal transmission on each port. Optionally, the CS corresponding to the each port for the first SRS is determined based on at least one of a cyclic shift offset value, a maximum cyclic shift offset value, a first parameter, a comb structure size, a port number, or the number of ports; and/or
a comb position mapped by the each port for the first SRS is determined based on at least one of a comb offset value, the comb structure size, the cyclic shift offset value, the maximum cyclic shift offset value, the first parameter, or the port number.

The first parameter is a value agreed by default between a network-side device and the terminal and/or a value indicated by the network-side device and/or a value reported by the terminal.

This embodiment of this application provides a method for determining CSs corresponding to ports for SRSs and comb positions mapped by the ports, which can improve the orthogonality of SRS reference signal transmission on the ports, thereby improving the performance of uplink transmission.

Optionally, in a case that the number of ports is 8 and the comb structure size is 2, a CS mapping method 1 is as follows:

Different ports for the first SRS correspond to different CSs, that is, eight ports use different CSs; where
a CS corresponding to the each port for the first SRS is obtained through calculation by using the following formula:

$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports, where

$${p}_{i} = 1000 + i .$$

It should be noted that n_{SRS}^{cs}∈{0, 1, . . . , n_{SRS}^{cs,max}−1} is a cyclic shift offset value configured by the network-side device through RRC signaling. The maximum cyclic shift offset value, namely n_{SRS}^{cs,max}, is n_{SRS}^{cs,max}=6 if K_{TC}=8, n_{SRS}^{cs,max}=12 if K_{TC}=4, and n_{SRS}^{cs,max}=8 if K_{TC}=2, where K_{TC} is the comb structure size.

For the CS mapping method 1, CS values corresponding to ports are shown in Table 1.

TABLE 1
CS values corresponding to ports

| | 1000 | 1001 | 1002 | 1003 | 1004 | 1005 | 1006 | 1007 |
|---|---|---|---|---|---|---|---|---|
| Initial CS 0 | 0 | 1 | 2 | 3 | 4 | 5 | 6 | 7 |
| Initial CS 1 | 1 | 2 | 3 | 4 | 5 | 6 | 7 | 0 |
| Initial CS 2 | 2 | 3 | 4 | 5 | 6 | 7 | 0 | 1 |
| Initial CS 3 | 3 | 4 | 5 | 6 | 7 | 0 | 1 | 2 |
| Initial CS 4 | 4 | 5 | 6 | 7 | 0 | 1 | 2 | 3 |
| Initial CS 5 | 5 | 6 | 7 | 0 | 1 | 2 | 3 | 4 |
| Initial CS 6 | 6 | 7 | 0 | 1 | 2 | 3 | 4 | 5 |
| Initial CS 7 | 7 | 0 | 1 | 2 | 3 | 4 | 5 | 6 |

It should be noted that the initial CS in each table in this application is a cyclic shift offset value n_{SRS}^{cs}.

Optionally, in a case that the number of ports is 8, the comb structure size is 2, and the CS mapping method 1 is used, a corresponding comb position mapping method 1 is as follows:

The each port for the first SRS is mapped to a same comb position, and a comb position mapped by the each port for the first SRS is obtained through calculation by using the following formula:

k_{TC}^{(p}^{ᵢ}⁾=k̅_{TC}, where
k_{TC}^{(p}^{ᵢ}⁾ is a comb position mapped by port i, and k̅_{TC} is the comb offset value.

It should be noted that in the embodiments of this application, the comb offset value k̅_{TC}∈{0, 1, . . . , K_{TC}−1} is configured by the network-side device through RRC signaling, where K_{TC} is a comb structure size, for example, for comb-4, K_{TC}=4.

Optionally, in a case that the number of ports is 8, the comb structure size is 2, and the CS mapping method 1 is used, a corresponding comb position mapping method 2 is as follows:

Eight ports for the first SRS are divided into two groups, comb positions mapped by ports in a same group are the same, and ports in different groups are mapped to different comb positions.

That is, ports {1001, 1003, 1005, 1007} are one group and mapped to a same first comb position; and ports {1000, 1002, 1004, 1006} are one group and mapped to a same second comb position. The first comb position and the second comb position are different.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 , 1006 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8, the comb structure size is 2, and the CS mapping method 1 is used, a corresponding comb position mapping method 3 is as follows:

The comb position mapped by the each port for the first SRS is related to the cyclic shift offset value; and for a specific cyclic shift offset value, eight ports for the first SRS are divided into two groups, comb positions mapped by ports in a same group are the same, and ports in different groups are mapped to different comb positions.

That is, the FDM multiplexing mode between ports is related to the cyclic shift offset value n_{SRS}^{cs}. The ports are grouped, and for a specific cyclic shift offset value, ports in different groups are mapped to different comb positions.

A comb position mapped by the each port for the first SRS is obtained through calculation by using the following formula:

$${k}_{TC}^{( {p}_{i} )} = \{ \begin{matrix}\begin{matrix}( {\overline{k}}_{TC} + {K}_{TC} / 2 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}\begin{matrix}( {\overline{k}}_{TC} + {K}_{TC} / 2 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1000 , 1002 , 1004 , 1006 \}\end{matrix} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 2, a CS mapping method 2 is as follows:

The ports are grouped, ports in different groups correspond to different CSs, and ports in a same group use a same CS.

Optionally, eight ports for the first SRS are divided into four groups, ports in a same group use a same CS, and ports in different groups use different CSs.

That is, ports {1000, 1001} are one group and use a same CS; ports {1002, 1003} are one group and use a same CS; ports {1004, 1005} are one group and use a same CS; and ports {1006, 1007} are one group and use a same CS.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

For the CS mapping method 2, CS values corresponding to ports are shown in Table 2.

TABLE 2
CS values corresponding to ports

| | 1000 | 1001 | 1002 | 1003 | 1004 | 1005 | 1006 | 1007 |
|---|---|---|---|---|---|---|---|---|
| Initial CS 0 | 0 | 0 | 2 | 2 | 4 | 4 | 6 | 6 |
| Initial CS 1 | 1 | 1 | 3 | 3 | 5 | 5 | 7 | 7 |
| Initial CS 2 | 2 | 2 | 4 | 4 | 6 | 6 | 0 | 0 |
| Initial CS 3 | 3 | 3 | 5 | 5 | 7 | 7 | 1 | 1 |
| Initial CS 4 | 4 | 4 | 6 | 6 | 0 | 0 | 2 | 2 |
| Initial CS 5 | 5 | 5 | 7 | 7 | 1 | 1 | 3 | 3 |
| Initial CS 6 | 6 | 6 | 0 | 0 | 2 | 2 | 4 | 4 |
| Initial CS 7 | 7 | 7 | 1 | 1 | 3 | 3 | 5 | 5 |

Optionally, in a case that the number of ports is 8, the comb structure size is 2, and the CS mapping method 2 is used, a corresponding comb position mapping method 4 is as follows:

The ports are grouped, and ports in different groups are mapped to different comb positions.

Optionally, eight ports for the first SRS are divided into two groups, comb positions mapped by ports in a same group are the same, and ports in different groups are mapped to different comb positions.

That is, ports {1001, 1003, 1005, 1007} are mapped to a same first comb position; and ports {1000, 1002, 1004, 1006} are mapped to a same second comb position. The first comb position and the second comb position are different.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 , 1006 \} \\ {\overline{k}}_{TC} & otherwise\end{matrix} ,$$

k_{TC}^{(p}^{ᵢ}⁾ is a comb position mapped by port i, k̅_{TC} is the comb offset value, and K_{TC} is the comb structure size.

This embodiment of this application provides the CS mapping method and comb position mapping method used for a case that the number of ports for SRSs is 8 and the comb structure size is 2, which can be used to improve the orthogonality of SRS reference signal transmission on the ports, and improve the performance of uplink transmission.

Optionally, in a case that the number of ports is 8 and the comb structure size is 4, a CS mapping method 3 is as follows:

The ports are grouped, ports in different groups correspond to different CSs, and ports in a same group use a same CS.

Optionally, eight ports for the first SRS are divided into four groups, ports in the same group use a same CS, and ports in different groups use different CSs, that is, ports {1000, 1001} use a same CS; ports {1002, 1003} use a same CS; ports {1004, 1005} use a same CS; and ports {1006, 1007} use a same CS.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

For the CS mapping method 3, CS values corresponding to ports are shown in Table 3.

TABLE 3
CS values corresponding to ports

| | 1000 | 1001 | 1002 | 1003 | 1004 | 1005 | 1006 | 1007 |
|---|---|---|---|---|---|---|---|---|
| Initial CS 0 | 0 | 0 | 3 | 3 | 6 | 6 | 9 | 9 |
| Initial CS 1 | 1 | 1 | 4 | 4 | 7 | 7 | 10 | 10 |
| Initial CS 2 | 2 | 2 | 5 | 5 | 8 | 8 | 11 | 11 |
| Initial CS 3 | 3 | 3 | 6 | 6 | 9 | 9 | 0 | 0 |
| Initial CS 4 | 4 | 4 | 7 | 7 | 10 | 10 | 1 | 1 |
| Initial CS 5 | 5 | 5 | 8 | 8 | 11 | 11 | 2 | 2 |
| Initial CS 6 | 6 | 6 | 9 | 9 | 0 | 0 | 3 | 3 |
| Initial CS 7 | 7 | 7 | 10 | 10 | 1 | 1 | 4 | 4 |
| Initial CS 8 | 8 | 8 | 11 | 11 | 2 | 2 | 5 | 5 |
| Initial CS 9 | 9 | 9 | 0 | 0 | 3 | 3 | 6 | 6 |
| Initial CS 10 | 10 | 10 | 1 | 1 | 4 | 4 | 7 | 7 |
| Initial CS 11 | 11 | 11 | 2 | 2 | 5 | 5 | 8 | 8 |

Optionally, in a case that the number of ports is 8, the comb structure size is 4, and the CS mapping method 3 is used, a corresponding comb position mapping method 5 is as follows:

Eight ports for the first SRS are divided into two groups, comb positions mapped by ports in a same group are the same, and ports in different groups are mapped to different comb positions, that is, ports {1001, 1003, 1005, 1007} are mapped to a same first comb position, and ports {1000, 1002, 1004, 1006} are mapped to a same second comb position. The first comb position and the second comb position are different.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 , 1006 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8, the comb structure size is 4, and the CS mapping method 3 is used, a corresponding comb position mapping method 6 is as follows:

The comb position mapped by the each port for the first SRS is related to the cyclic shift offset value. Ports are grouped, and for a specific cyclic shift offset value, ports in different groups are mapped to different comb positions.

A comb position mapped by the each port for the first SRS is obtained through calculation by using the following formula:

$${k}_{TC}^{( {p}_{i} )} = \{ \begin{matrix}\begin{matrix}( {\overline{k}}_{TC} + 1 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 10 \; 01 , 1005 \}\end{matrix} \\ \begin{matrix}( {\overline{k}}_{TC} + 2 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1002 , 1006 \}\end{matrix} \\ \begin{matrix}( {\overline{k}}_{TC} + 3 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1003 , 1007 \}\end{matrix} \\ \begin{matrix}( {\overline{k}}_{TC} + {K}_{TC} / 2 ) mod {K}_{TC} \\ \end{matrix} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}( {\overline{k}}_{TC} + ( {p}_{i} - 1000 ) mod {K}_{TC} & if {n}_{SRS}^{cs} ∈ \{ {n}_{SRS}^{cs , max} / 2 , … , {n}_{SRS}^{cs , max} - 1 \} \\ \begin{matrix}( {\overline{k}}_{TC} + {K}_{TC} / 2 ) mod {K}_{TC} \\ \end{matrix} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}( {\overline{k}}_{TC} + ( {p}_{i} - 1000 ) & if {n}_{SRS}^{cs} ∈ \{ {n}_{SRS}^{cs , max} / 2 , … , \\ mod 4 ) mod {K}_{TC} & {n}_{SRS}^{cs , max} - 1 \} \\ ( {\overline{k}}_{TC} + {K}_{TC} / 2 ) mod {K}_{TC} & if {n}_{SRS}^{cs} ∉ \{ {n}_{SRS}^{cs , max} / 2 , … , {n}_{SRS}^{cs , max} - 1 \} and \\ & {p}_{i} ∈ \{ 1001 , 1003 , 1005 , 1007 \} \\ {\overline{k}}_{TC} & otherwise\end{matrix} \}$$

$$or$$

$${k}_{TC}^{( {p}_{i} )} = \{ \begin{matrix}\begin{matrix}( {\overline{k}}_{TC} + 1 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1002 , 1006 \}\end{matrix} \\ \begin{matrix}( {\overline{k}}_{TC} + 2 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1005 \}\end{matrix} \\ \begin{matrix}( {\overline{k}}_{TC} + 3 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1003 , 1007 \}\end{matrix} \\ \begin{matrix}( {\overline{k}}_{TC} + {K}_{TC} / 2 ) mod {K}_{TC} \\ \end{matrix} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}\begin{matrix}( {\overline{k}}_{TC} + {K}_{TC} / 2 - 1 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1002 , 1006 \}\end{matrix} \\ \begin{matrix}( {\overline{k}}_{TC} + {K}_{TC} / 2 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1005 \}\end{matrix} \\ \begin{matrix}( {\overline{k}}_{TC} + {K}_{TC} / 2 + 1 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1003 , 1007 \}\end{matrix} \\ \begin{matrix}( {\overline{k}}_{TC} + {K}_{TC} / 2 ) mod {K}_{TC} \\ \end{matrix} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix} ,$$

k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 4, a CS mapping method 4 is used as follows: The ports are grouped. Ports in different groups correspond to different CSs, and ports in a same group use a same CS. Eight ports for the first SRS are divided into two groups, ports in a same group use a same CS, and ports in different groups use different CSs.

That is, ports {1000, 1001, 1002, 1003} use a same CS; and ports {1004, 1005, 1006, 1007} use a same CS.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max}$$

$$or$$

$${n}_{SRS}^{cs , i} = [ {n}_{SRS}^{cs} + \frac{{n}_{SRS}^{cs , max} \cdot ⌊ ( {p}_{i} - 1000 ) / {K}_{TC} ⌋ \cdot {K}_{TC}}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, x is the first parameter, x is a value agreed by default between the network-side device and the terminal and/or a value indicated by the network-side device and/or a value reported by the terminal, x=4, and K_{TC} is the comb structure size.

For the CS mapping method 4, CS values corresponding to ports are shown in Table 4.

TABLE 4
CS values corresponding to ports

| | 1000 | 1001 | 1002 | 1003 | 1004 | 1005 | 1006 | 1007 |
|---|---|---|---|---|---|---|---|---|
| Initial CS 0 | 0 | 0 | 0 | 0 | 6 | 6 | 6 | 6 |
| Initial CS 1 | 1 | 1 | 1 | 1 | 7 | 7 | 7 | 7 |
| Initial CS 2 | 2 | 2 | 2 | 2 | 8 | 8 | 8 | 8 |
| Initial CS 3 | 3 | 3 | 3 | 3 | 9 | 9 | 9 | 9 |
| Initial CS 4 | 4 | 4 | 4 | 4 | 10 | 10 | 10 | 10 |
| Initial CS 5 | 5 | 5 | 5 | 5 | 11 | 11 | 11 | 11 |
| Initial CS 6 | 6 | 6 | 6 | 6 | 0 | 0 | 0 | 0 |
| Initial CS 7 | 7 | 7 | 7 | 7 | 1 | 1 | 1 | 1 |
| Initial CS 8 | 8 | 8 | 8 | 8 | 2 | 2 | 2 | 2 |
| Initial CS 9 | 9 | 9 | 9 | 9 | 3 | 3 | 3 | 3 |
| Initial CS 10 | 10 | 10 | 10 | 10 | 4 | 4 | 4 | 4 |
| Initial CS 11 | 11 | 11 | 11 | 11 | 5 | 5 | 5 | 5 |

Optionally, in a case that the number of ports is 8, the comb structure size is 4, and the CS mapping method 4 is used, a corresponding comb position mapping method 7 is as follows:

Eight ports for the first SRS are divided into four groups, comb positions mapped by ports in a same group are the same, and ports in different groups are mapped to different comb positions. That is, ports {1000, 1004} are mapped to a same first comb position, ports {1001, 1005} is mapped to a same second comb position, ports {1002, 1006} are mapped to a same third comb position, and ports {1003, 1007} are mapped to a same fourth comb position, where the first comb position, the second comb position, the third comb position, and the fourth comb position are different.

A comb position mapped by the each port for the first SRS is obtained through calculation by using the following formula:

$${k}_{T C}^{( {p}_{i} )} = \{ \begin{matrix}{\overline{k}}_{T C} & if {p}_{i} ∈ \{ 10 \; 00 , 1004 \} \\ ( {\overline{k}}_{T C} + 1 ) mod {K}_{T C} & if {p}_{i} ∈ \{ 10 \; 01 , 1005 \} \\ ( {\overline{k}}_{T C} + 2 ) mod {K}_{T C} & if {p}_{i} ∈ \{ 10 \; 02 , 1006 \} \\ ( {\overline{k}}_{T C} + 3 ) mod {K}_{T C} & if {p}_{i} ∈ \{ 10 \; 03 , 1007 \}\end{matrix}$$

$$or$$

$${k}_{T C}^{( {p}_{i} )} = ( {\overline{k}}_{T C} + ( {p}_{i} - 10 \; 00 ) mod {K}_{T C} ) mod {K}_{T C}$$

$$or$$

$${k}_{T C}^{( {p}_{i} )} = {\overline{k}}_{T C} + ( {p}_{i} - 1000 ) mod 4 ) mod {K}_{T C}$$

$$or$$

$${k}_{T C}^{( {p}_{i} )} = ( {\overline{k}}_{T C} + ( {p}_{i} - 1000 ) mod x ) mod {K}_{T C} ,$$

where
k_{TC}^{(p}^{ᵢ}⁾ is a comb position mapped by port i, k̅_{TC} is the comb offset value, and x is the first parameter, where x is a value agreed by default between the network-side device and the terminal and/or a value indicated by the network-side device and/or a value reported by the terminal, and x=4.

This embodiment of this application provides the CS mapping method and comb position mapping method used for a case that the number of ports for SRSs is 8 and the comb structure size is 4, which can be used to improve the orthogonality of SRS reference signal transmission on the ports, and improve the performance of uplink transmission.

Optionally, in a case that the number of ports is 8 and the comb structure size is 8, a CS mapping method 5 is as follows:

Eight ports for the first SRS are divided into two groups, ports in the same group use a same CS, and ports in different groups use different CSs, that is, ports {1000, 1001, 1002, 1003} use a same CS, and ports {1004, 1005, 1006, 1007} use a same CS.

A CS corresponding to the each port for the first SRS is obtained through calculation by using the following formula:

$${n}_{S R S}^{cs , i} = [ {n}_{S R S}^{c s} + \frac{{n}_{S R S}^{cs , max} \cdot ⌊ ( {p}_{i} - 1000 ) / x ⌋ \cdot x}{{N}_{a p}^{S R S}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=4.

For the CS mapping method 5, CS values corresponding to ports are shown in Table 5.

TABLE 5
CS values corresponding to ports

| | 1000 | 1001 | 1002 | 1003 | 1004 | 1005 | 1006 | 1007 |
|---|---|---|---|---|---|---|---|---|
| Initial CS 0 | 0 | 0 | 0 | 0 | 3 | 3 | 3 | 3 |
| Initial CS 1 | 1 | 1 | 1 | 1 | 4 | 4 | 4 | 4 |
| Initial CS 2 | 2 | 2 | 2 | 2 | 5 | 5 | 5 | 5 |
| Initial CS 3 | 3 | 3 | 3 | 3 | 0 | 0 | 0 | 0 |
| Initial CS 4 | 4 | 4 | 4 | 4 | 1 | 1 | 1 | 1 |
| Initial CS 5 | 5 | 5 | 5 | 5 | 2 | 2 | 2 | 2 |

Optionally, in a case that the number of ports is 8, the comb structure size is 8, and the CS mapping method 5 is used, a corresponding comb position mapping method 8 is as follows:

Eight ports for the first SRS are divided into four groups, comb positions mapped by ports in a same group are the same, and ports in different groups are mapped to different comb positions. That is, ports {1000, 1004} are mapped to a same first comb position, ports {1001, 1005} is mapped to a same second comb position, ports {1002, 1006} are mapped to a same third comb position, and ports {1003, 1007} are mapped to a same fourth comb position, where the first comb position, the second comb position, the third comb position, and the fourth comb position are different.

A comb position mapped by the each port for the first SRS is obtained through calculation by using the following formula:

$${k}_{T C}^{( {p}_{i} )} = \{ \begin{matrix}{\overline{k}}_{T C} & if {p}_{i} ∈ \{ 10 \; 00 , 1004 \} \\ ( {\overline{k}}_{T C} + 2 ) mod {K}_{T C} & if {p}_{i} ∈ \{ 10 \; 01 , 1005 \} \\ ( {\overline{k}}_{T C} + 4 ) mod {K}_{T C} & if {p}_{i} ∈ \{ 10 \; 02 , 1006 \} \\ ( {\overline{k}}_{T C} + 6 ) mod {K}_{T C} & if {p}_{i} ∈ \{ 10 \; 03 , 1007 \}\end{matrix}$$

$$or$$

$${k}_{T C}^{( {p}_{i} )} = ( {\overline{k}}_{T C} + ( 2 ( {p}_{i} - 1000 ) ) mod 4 ) mod {K}_{T C}$$

$$or$$

$${k}_{T C}^{( {p}_{i} )} = ( {\overline{k}}_{T C} + ( 8 / x \cdot ( {p}_{i} - 1000 ) ) mod x ) mod {K}_{T C} ,$$

where
k_{TC}^{(p}^{ᵢ}⁾ is a comb position mapped by port i, k̅_{TC} is the comb offset value, and K_{TC} is the comb structure size, and x is the first parameter, where x is a value agreed by default between the network-side device and the terminal and/or a value indicated by the network-side device and/or a value reported by the terminal, and x=4.

Optionally, in a case that the number of ports is 8 and the comb structure size is 8, a CS mapping method 6 is as follows:

Eight ports for the first SRS all use a same CS, and a CS corresponding to the each port for the first SRS is obtained through calculation by using the following formula:

$${n}_{S R S}^{cs , i} = [ {n}_{S R S}^{c s} + \frac{{n}_{S R S}^{cs , max} \cdot ⌊ ( {p}_{i} - 1000 ) / x ⌋ \cdot x}{{N}_{a p}^{S R S}} ] mod {n}_{S R S}^{cs , max}$$

or
n_{SRS}^{cs,i}=n_{SRS}^{cs}, where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=8.

For the CS mapping method 6, CS values corresponding to ports are shown in Table 6.

TABLE 6
CS values corresponding to ports

| | 1000 | 1001 | 1002 | 1003 | 1004 | 1005 | 1006 | 1007 |
|---|---|---|---|---|---|---|---|---|
| Initial CS 0 | 0 | 0 | 0 | 0 | 0 | 0 | 0 | 0 |
| Initial CS 1 | 1 | 1 | 1 | 1 | 1 | 1 | 1 | 1 |
| Initial CS 2 | 2 | 2 | 2 | 2 | 2 | 2 | 2 | 2 |
| Initial CS 3 | 3 | 3 | 3 | 3 | 3 | 3 | 3 | 3 |
| Initial CS 4 | 4 | 4 | 4 | 4 | 4 | 4 | 4 | 4 |
| Initial CS 5 | 5 | 5 | 5 | 5 | 5 | 5 | 5 | 5 |

Optionally, in a case that the number of ports is 8, the comb structure size is 8, and the CS mapping method 6 is used, a corresponding comb position mapping method 9 is as follows:

Different ports for the first SRS are mapped to different comb positions.

It should be noted that mapping different ports for the first SRS to different comb positions can also be understood as grouping ports, with each port in one group, and ports in different groups are mapped to different comb positions, that is, different ports are mapped to different comb positions.

A comb position mapped by the each port for the first SRS is obtained through calculation by using the following formula:

$${k}_{T C}^{( {p}_{i} )} = \{ \begin{matrix}{\overline{k}}_{T C} & if {p}_{i} ∈ \{ 1000 \} \\ ( {\overline{k}}_{T C} + 1 ) mod {K}_{T C} & if {p}_{i} ∈ \{ 1001 \} \\ ( {\overline{k}}_{T C} + 2 ) mod {K}_{T C} & if {p}_{i} ∈ \{ 1002 \} \\ ( {\overline{k}}_{T C} + 3 ) mod {K}_{T C} & if {p}_{i} ∈ \{ 1003 \} \\ ( {\overline{k}}_{T C} + 4 ) mod {K}_{T C} & if {p}_{i} ∈ \{ 1004 \} \\ ( {\overline{k}}_{T C} + 5 ) mod {K}_{T C} & if {p}_{i} ∈ \{ 1005 \} \\ ( {\overline{k}}_{T C} + 6 ) mod {K}_{T C} & if {p}_{i} ∈ \{ 1006 \} \\ ( {\overline{k}}_{T C} + 7 ) mod {K}_{T C} & if {p}_{i} ∈ \{ 1007 \}\end{matrix}$$

$$or$$

$${k}_{T C}^{( {p}_{i} )} = ( {\overline{k}}_{T C} + {p}_{i} - 10 \; 00 ) mod {K}_{T C}$$

$$or$$

$${k}_{T C}^{( {p}_{i} )} = ( {\overline{k}}_{T C} + ( 8 / x \cdot ( {p}_{i} - 1000 ) ) mod x ) mod {K}_{T C} ,$$

where
k_{TC}^{(p}^{ᵢ}⁾ is a comb position mapped by port i, k̅_{TC} is the comb offset value, and K_{TC} is the K_{TC} comb structure size.

This embodiment of this application provides the CS mapping method and comb position mapping method used for a case that the number of ports for SRSs is 8 and the comb structure size is 8, which can be used to improve the orthogonality of SRS reference signal transmission on the ports, and improve the performance of uplink transmission.

Optionally, in a case that the number of ports is 6 and the comb structure size is 2, a CS mapping method 7 is as follows:

Different ports for the first SRS use different CSs, and different ports correspond to different CSs through rounding down.

A CS corresponding to the each port for the first SRS is obtained through calculation by using the following formula:

$${n}_{S R S}^{cs , i} = [ {n}_{S R S}^{c s} + ⌊ \frac{{n}_{S R S}^{cs , max} ( {p}_{i} - 1000 )}{{N}_{a p}^{S R S}} ⌋ ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

For the CS mapping method 7, CS values corresponding to ports are shown in Table 7.

TABLE 7
CS values corresponding to ports

| | 1000 | 1001 | 1002 | 1003 | 1004 | 1005 |
|---|---|---|---|---|---|---|
| Initial CS 0 | 0 | 1 | 2 | 4 | 5 | 6 |
| Initial CS 1 | 1 | 2 | 3 | 5 | 6 | 7 |
| Initial CS 2 | 2 | 3 | 4 | 6 | 7 | 0 |
| Initial CS 3 | 3 | 4 | 5 | 7 | 0 | 1 |
| Initial CS 4 | 4 | 5 | 6 | 0 | 1 | 2 |
| Initial CS 5 | 5 | 6 | 7 | 1 | 2 | 3 |
| Initial CS 6 | 6 | 7 | 0 | 2 | 3 | 4 |
| Initial CS 7 | 7 | 0 | 1 | 3 | 4 | 5 |

Optionally, in a case that the number of ports is 6, the comb structure size is 2, and the CS mapping method 7 is used, a corresponding comb position mapping method 10 is as follows:

Six ports for the first SRS are divided into two groups, comb positions mapped by ports in a same group are the same, and ports in different groups are mapped to different comb positions.

In an implementation, ports {1000, 1002, 1003, 1005} are one group and mapped to a same first comb position; and ports {1001, 1004} are one group and mapped to a same second comb position. The first comb position and the second comb position are different.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1003 , 1005 \} \\ {\overline{k}}_{T C} & otherwise\end{matrix}$$

In this case, a port for the second SRS and ports {1001, 1004} for the first SRS are allowed to map to a same comb position.

It should be noted that the second SRS is one 2-port SRS; or the second SRS is one N-port SRS, where N>2, and two of the ports and the ports {1001, 1004} for the first SRS are mapped to a same comb position.

A cyclic shift offset value corresponding to the second SRS is equal to a value obtained by performing remainder calculation on a maximum cyclic shift offset value nesmax corresponding to the first SRS after adding 3 to a cyclic shift offset value corresponding to the first SRS.

Alternatively, a comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1004 \} \\ {\overline{k}}_{T C} & otherwise\end{matrix}$$

In this case, a port for the second SRS and the ports {1001, 1004} for the first SRS are allowed to map to a same comb position. The second SRS is one 2-port SRS; or the second SRS is one N-port SRS, where N>2, and two of the ports and the ports {1001, 1004} for the first SRS are mapped to a same comb position.

A cyclic shift offset value corresponding to the second SRS is equal to a value obtained by performing remainder calculation on a maximum cyclic shift offset value corresponding to the first SRS after adding 3 to a cyclic shift offset value corresponding to the first SRS.

In another implementation, ports {1000, 1002, 1004} are one group and mapped to a same first comb position; and ports {1001, 1003, 1005} are one group and mapped to a same second comb position. The first comb position and the second comb position are different. A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 \} \\ {\overline{k}}_{T C} & otherwise\end{matrix}$$

$$or$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 10 \; 03 , 1005 \} \\ {\overline{k}}_{T C} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 2, a CS mapping method 8 is as follows:

Different ports for the first SRS use different CSs, and different ports correspond to different CSs through rounding up.

A CS corresponding to the each port for the first SRS is obtained through calculation by using the following formula:

$${n}_{SRS}^{cs , i} = [ {n}_{SRS}^{c s} + ⌈ \frac{{n}_{SRS}^{cs , max} ( {p}_{i} - 1000 )}{{N}_{a p}^{SRS}} ⌉ ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

For the CS mapping method 8, CS values corresponding to ports are shown in Table 8.

TABLE 8
CS values corresponding to ports

| | 1000 | 1001 | 1002 | 1003 | 1004 | 1005 |
|---|---|---|---|---|---|---|
| Initial CS 0 | 0 | 2 | 3 | 4 | 6 | 7 |
| Initial CS 1 | 1 | 3 | 4 | 5 | 7 | 0 |
| Initial CS 2 | 2 | 4 | 5 | 6 | 0 | 1 |
| Initial CS 3 | 3 | 5 | 6 | 7 | 1 | 2 |
| Initial CS 4 | 4 | 6 | 7 | 0 | 2 | 3 |
| Initial CS 5 | 5 | 7 | 0 | 1 | 3 | 4 |
| Initial CS 6 | 6 | 0 | 1 | 2 | 4 | 5 |
| Initial CS 7 | 7 | 1 | 2 | 3 | 5 | 6 |

Optionally, in a case that the number of ports is 6, the comb structure size is 2, and the CS mapping method 8 is used, a corresponding comb position mapping method 11 is as follows:

Six ports for the first SRS are divided into two groups, comb positions mapped by ports in a same group are the same, ports in different groups are mapped to different comb positions, and the number of ports in each group may be different.

In an implementation, ports {1000, 1001, 1003, 1004} are one group and mapped to a same first comb position; and ports {1002, 1005} are one group and mapped to a same second comb position. The first comb position and the second comb position are different.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1001 , 1003 , 1004 \} \\ {\overline{k}}_{T C} & otherwise\end{matrix}$$

In this case, a port for the third SRS and ports {1002, 1005} for the first SRS are allowed to map to a same comb position.

It should be noted that the third SRS is one 2-port SRS; or the third SRS is one N-port SRS, where N>2, and two of the ports and the ports {1002, 1005} for the first SRS are mapped to a same comb position.

A cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

Alternatively, a comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 02 , 1005 \} \\ {\overline{k}}_{T C} & otherwise\end{matrix}$$

In this case, a port for the third SRS and ports {1002, 1005} for the first SRS are allowed to map to a same comb position.

It should be noted that the third SRS is one 2-port SRS; or the third SRS is one N-port SRS, where N>2, and two of the ports and the ports {1002, 1005} for the first SRS are mapped to a same comb position.

A cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

In another implementation, ports {1000, 1002, 1004} are one group and mapped to a same first comb position; and ports {1001, 1003, 1005} are one group and mapped to a same second comb position. The first comb position and the second comb position are different.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 \} \\ {\overline{k}}_{T C} & otherwise\end{matrix}$$

$$or$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 \} \\ {\overline{k}}_{T C} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 2, a CS mapping method 9 is as follows:

Different ports for the first SRS use different CSs, some ports are rounded up, and some ports are rounded down.

A CS corresponding to the each port for the first SRS is obtained through calculation by using the following formula:

$${n}_{SRS}^{cs , i} = \{ \begin{matrix}[ {n}_{S R S}^{c s} + ⌊ \frac{{n}_{S R S}^{cs , max} ( {p}_{i} - 1000 )}{{N}_{a p}^{SRS}} ⌋ ] mod {n}_{S R S}^{cs , max} if {p}_{i} ∈ \{ 10 \; 01 , 1004 \} \\ [ {n}_{S R S}^{c s} + ⌈ \frac{{n}_{S R S}^{cs , max} ( {p}_{i} - 1000 )}{{N}_{a p}^{SRS}} ⌉ ] mod {n}_{S R S}^{cs , max} if {p}_{i} ∈ \{ 10 \; 02 , 1005 \} , where \\ [ {n}_{S R S}^{c s} + \frac{{n}_{S R S}^{cs , max} ( {p}_{i} - 1000 )}{{N}_{a p}^{SRS}} ] mod {n}_{S R S}^{cs , max} otherwise\end{matrix}$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

For the CS mapping method 9, CS values corresponding to ports are shown in Table 9.

TABLE 9
CS values corresponding to ports

| | 1000 | 1001 | 1002 | 1003 | 1004 | 1005 |
|---|---|---|---|---|---|---|
| Initial CS 0 | 0 | 1 | 3 | 4 | 5 | 7 |
| Initial CS 1 | 1 | 2 | 4 | 5 | 6 | 0 |
| Initial CS 2 | 2 | 3 | 5 | 6 | 7 | 1 |
| Initial CS 3 | 3 | 4 | 6 | 7 | 0 | 2 |
| Initial CS 4 | 4 | 5 | 7 | 0 | 1 | 3 |
| Initial CS 5 | 5 | 6 | 0 | 1 | 2 | 4 |
| Initial CS 6 | 6 | 7 | 1 | 2 | 3 | 5 |
| Initial CS 7 | 7 | 0 | 2 | 3 | 4 | 6 |

Optionally, in a case that the number of ports is 6, the comb structure size is 2, and the CS mapping method 9 is used, a corresponding comb position mapping method 12 is as follows:

Six ports for the first SRS are divided into two groups, comb positions mapped by ports in a same group are the same, ports in different groups are mapped to different comb positions, and the number of ports in each group may be different.

In an implementation, ports {1001, 1002, 1004, 1005} are one group and mapped to a same first comb position; and ports {1000, 1003} are one group and mapped to a same second comb position. The first comb position and the second comb position are different.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1002 , 1004 , 1005 \} \\ {\overline{k}}_{T C} & otherwise\end{matrix}$$

In this case, a port for the fourth SRS and ports {1000, 1003} for the first SRS are allowed to map to a same comb position.

It should be noted that the fourth SRS is one 2-port SRS; or the fourth SRS is one N-port SRS, where N>2, and two of the ports and the ports {1000, 1003} for the first SRS are mapped to a same comb position.

A cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

Alternatively, a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1003 \} \\ {\overline{k}}_{TC} & otherwise\end{matrix}$$

In this case, a port for the fourth SRS and ports {1000, 1003} for the first SRS are allowed to map to a same comb position.

It should be noted that the fourth SRS is one 2-port SRS; or the fourth SRS is one N-port SRS, where N>2, and two of the ports and the ports {1000, 1003} for the first SRS are mapped to a same comb position.

A cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

In another implementation, ports {1000, 1002, 1004} are one group and mapped to a same first comb position; and ports {1001, 1003, 1005} are one group and mapped to a same second comb position. The first comb position and the second comb position are different.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} or , \\ {\overline{k}}_{TC} & otherwise\end{matrix}$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 2, a CS mapping method is as follows:

Different ports for the first SRS use different CSs, some ports are rounded up, and some ports are rounded down.

ACS corresponding to the each port for the first SRS is obtained through calculation by using the following formula:

$${n}_{SRS}^{cs , i} = \{ \begin{matrix}[ {n}_{SRS}^{cs} + ⌊ \frac{{n}_{SRS}^{cs , max} ( {p}_{i} - 1000 )}{{N}_{ap}^{SRS}} ⌋ ] mod {n}_{SRS}^{cs , max} & if {p}_{i} ∈ \{ 1001 \} \\ [ {n}_{SRS}^{cs} + ⌈ \frac{{n}_{SRS}^{cs , max} ( {p}_{i} - 1000 )}{{N}_{ap}^{SRS}} ⌉ ] mod {n}_{SRS}^{cs , max} & \begin{matrix}if {p}_{i} ∈ \{ 1002 , 1004 , 1005 \} , \\ where\end{matrix} \\ [ {n}_{SRS}^{cs} + \frac{{n}_{SRS}^{cs , max} ( {p}_{i} - 1000 )}{{N}_{ap}^{SRS}} ] mod {n}_{SRS}^{cs , max} & otherwise\end{matrix}$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

For the CS mapping method 10, CS values corresponding to ports are shown in Table 10.

TABLE 10
CS values corresponding to ports

| | 1000 | 1001 | 1002 | 1003 | 1004 | 1005 |
|---|---|---|---|---|---|---|
| Initial CS 0 | 0 | 1 | 3 | 4 | 6 | 7 |
| Initial CS 1 | 1 | 2 | 4 | 5 | 7 | 0 |
| Initial CS 2 | 2 | 3 | 5 | 6 | 0 | 1 |
| Initial CS 3 | 3 | 4 | 6 | 7 | 1 | 2 |
| Initial CS 4 | 4 | 5 | 7 | 0 | 2 | 3 |
| Initial CS 5 | 5 | 6 | 0 | 1 | 3 | 4 |
| Initial CS 6 | 6 | 7 | 1 | 2 | 4 | 5 |
| Initial CS 7 | 7 | 0 | 2 | 3 | 5 | 6 |

Optionally, in a case that the number of ports is 6, the comb structure size is 2, and the CS mapping method 10 is used, a corresponding comb position mapping method 13 is as follows:

Six ports for the first SRS are divided into two groups, comb positions mapped by ports in a same group are the same, ports in different groups are mapped to different comb positions, and the number of ports in each group is the same.

That is, ports {1000, 1002, 1004} are one group and mapped to a same first comb position; and ports {1001, 1003, 1005} are one group and mapped to a same second comb position. The first comb position and the second comb position are different.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

This embodiment of this application provides the CS mapping method and comb position mapping method used for a case that the number of ports for SRSs is 6 and the comb structure size is 2, which can be used to improve the orthogonality of SRS reference signal transmission on the ports, and improve the performance of uplink transmission.

Optionally, in a case that the number of ports is 6 and the comb structure size is 4, a CS mapping method 11 is as follows:

Different ports for the first SRS use different CSs, that is, six ports use different CSs.

A CS corresponding to the each port for the first SRS is obtained through calculation by using the following formula:

$${n}_{SRS}^{cs , i} = [ {n}_{SRS}^{c s} + \frac{{n}_{SRS}^{cs , max} ( {p}_{i} - 1000 )}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

For the CS mapping method 11, CS values corresponding to ports are shown in Table 11.

TABLE 11
CS values corresponding to ports

| | 1000 | 1001 | 1002 | 1003 | 1004 | 1005 |
|---|---|---|---|---|---|---|
| Initial CS 0 | 0 | 2 | 4 | 6 | 8 | 10 |
| Initial CS 1 | 1 | 3 | 5 | 7 | 9 | 11 |
| Initial CS 2 | 2 | 4 | 6 | 8 | 10 | 0 |
| Initial CS 3 | 3 | 5 | 7 | 9 | 11 | 1 |
| Initial CS 4 | 4 | 6 | 8 | 10 | 0 | 2 |
| Initial CS 5 | 5 | 7 | 9 | 11 | 1 | 3 |
| Initial CS 6 | 6 | 8 | 10 | 0 | 2 | 4 |
| Initial CS 7 | 7 | 9 | 11 | 1 | 3 | 5 |
| Initial CS 8 | 8 | 10 | 0 | 2 | 4 | 6 |
| Initial CS 9 | 9 | 11 | 1 | 3 | 5 | 7 |
| Initial CS 10 | 10 | 0 | 2 | 4 | 6 | 8 |
| Initial CS 11 | 11 | 1 | 3 | 5 | 7 | 9 |

Optionally, in a case that the number of ports is 6, the comb structure size is 4, and the CS mapping method 11 is used, a corresponding comb position mapping method 14 is as follows:

The comb position mapped by the each port for the first SRS is related to the cyclic shift offset value; and for a specific cyclic shift offset value, six ports for the first SRS are divided into two groups, comb positions mapped by ports in a same group are the same, and ports in different groups are mapped to different comb positions. A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1003 , 1005 \}\end{matrix} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1000 , 1002 , 1004 \}\end{matrix} \\ {\overline{k}}_{TC} & otherwise\end{matrix} ,$$

where
k_{TC}^{(p}^{ᵢ}⁾ is a comb position mapped by port i, kc is the comb offset value, and K_{TC} is the comb structure size.

This embodiment of this application provides the CS mapping method and comb position mapping method used for a case that the number of ports for SRSs is 6 and the comb structure size is 4, which can be used to improve the orthogonality of SRS reference signal transmission on the ports, and improve the performance of uplink transmission.

Optionally, in a case that the number of ports is 6 and the comb structure size is 6, a CS mapping method 12 is as follows:

Six ports for the first SRS are divided into two groups, ports in the same group use a same CS, and ports in different groups use different CSs, that is, ports {1000, 1001, 1002} are one group and use a same CS, and ports {1003, 1004, 1005} are one group and use a same CS.

A CS corresponding to the each port for the first SRS is obtained through calculation by using the following formula:

$${n}_{SRS}^{cs , i} = [ {n}_{SRS}^{c s} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} on is the number of ports, and x is the first parameter, where x is a value agreed by default between the network-side device and the terminal and/or a value indicated by the network-side device and/or a value reported by the terminal, and x=3.

For the CS mapping method 12, CS values corresponding to ports are shown in Table 12.

TABLE 12
CS values corresponding to ports

| | 1000 | 1001 | 1002 | 1003 | 1004 | 1005 |
|---|---|---|---|---|---|---|
| Initial CS 0 | 0 | 0 | 0 | 4 | 4 | 4 |
| Initial CS 1 | 1 | 1 | 1 | 5 | 5 | 5 |
| Initial CS 2 | 2 | 2 | 2 | 6 | 6 | 6 |
| Initial CS 3 | 3 | 3 | 3 | 7 | 7 | 7 |
| Initial CS 4 | 4 | 4 | 4 | 0 | 0 | 0 |
| Initial CS 5 | 5 | 5 | 5 | 1 | 1 | 1 |
| Initial CS 6 | 6 | 6 | 6 | 2 | 2 | 2 |
| Initial CS 7 | 7 | 7 | 7 | 3 | 3 | 3 |

Optionally, in a case that the number of ports is 6, the comb structure size is 6, and the CS mapping method 12 is used, a corresponding comb position mapping method 15 is as follows:

Six ports for the first SRS are divided into three groups, comb positions mapped by ports in a same group are the same, and ports in different groups are mapped to different comb positions, that is, ports {1000, 1003} are mapped to a same first comb position, ports {1000, 1004} are mapped to a same second comb position, and ports {1002, 1005} are mapped to a same third comb position. The first comb position, the second comb position, and the third comb position are different.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix}$$

$$or$$

$${k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 10 \; 04 \} \\ ( {\overline{k}}_{TC} + {n}_{3} ) mod {K}_{TC} & if {p}_{i} ∈ \{ 1002 , 1005 \}\end{matrix} ,$$

where
k_{TC}^{(p}^{ᵢ}⁾ is a comb position mapped by port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

Optionally, n₁=2 and n₂=4.

Optionally, n₁=0, n₂=2, and n₃=4.

This embodiment of this application provides the CS mapping method and comb position mapping method used for a case that the number of ports for SRSs is 6 and the comb structure size is 6, which can be used to improve the orthogonality of SRS reference signal transmission on the ports, and improve the performance of uplink transmission.

Optionally, in a case that the number of ports is 6 and the comb structure size is 8, a CS mapping method 13 is as follows:

Different ports for the first SRS use different CSs, that is, six ports use different CSs.

A CS corresponding to the each port for the first SRS is obtained through calculation by using the following formula:

$${n}_{SRS}^{cs , i} = [ {n}_{SRS}^{c s} + \frac{{n}_{SRS}^{cs , max} ( {p}_{i} - 1000 )}{{N}_{ap}^{SRS}} ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

For the CS mapping method 13, CS values corresponding to ports are shown in Table 13.

TABLE 13
CS values corresponding to ports

| | 1000 | 1001 | 1002 | 1003 | 1004 | 1005 |
|---|---|---|---|---|---|---|
| Initial CS 0 | 0 | 1 | 2 | 3 | 4 | 5 |
| Initial CS 1 | 1 | 2 | 3 | 4 | 5 | 0 |
| Initial CS 2 | 2 | 3 | 4 | 5 | 0 | 1 |
| Initial CS 3 | 3 | 4 | 5 | 0 | 1 | 2 |
| Initial CS 4 | 4 | 5 | 0 | 1 | 2 | 3 |
| Initial CS 5 | 5 | 0 | 1 | 2 | 3 | 4 |

Optionally, in a case that the number of ports is 6, the comb structure size is 8, and the CS mapping method 13 is used, the corresponding comb position mapping method 16 is as follows:

The comb position mapped by the each port for the first SRS is related to the cyclic shift offset value; and for a specific cyclic shift offset value, six ports for the first SRS are divided into two groups, comb positions mapped by ports in a same group are the same, and ports in different groups are mapped to different comb positions. A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1003 , 1005 \}\end{matrix} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1000 , 1002 , 1004 \}\end{matrix} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 8, a CS mapping method 14 is as follows:

Six ports for the first SRS are divided into three groups, ports in the same group use a same CS, and ports in different groups use different CSs, that is, ports {1000, 1001} are one group and use a same CS, ports {1002, 1003} are one group and use a same CS, and ports {1004, 1005} are one group and use a same CS.

A CS corresponding to the each port for the first SRS is obtained through calculation by using the following formula:

$${n}_{SRS}^{cs , i} = [ {n}_{SRS}^{c s} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

For the CS mapping method 14, CS values corresponding to ports are shown in Table 14.

TABLE 14
CS values corresponding to ports

| | 1000 | 1001 | 1002 | 1003 | 1004 | 1005 |
|---|---|---|---|---|---|---|
| Initial CS 0 | 0 | 0 | 2 | 2 | 4 | 4 |
| Initial CS 1 | 1 | 1 | 3 | 3 | 5 | 5 |
| Initial CS 2 | 2 | 2 | 4 | 4 | 0 | 0 |
| Initial CS 3 | 3 | 3 | 5 | 5 | 1 | 1 |
| Initial CS 4 | 4 | 4 | 0 | 0 | 2 | 2 |
| Initial CS 5 | 5 | 5 | 1 | 1 | 3 | 3 |

In a case that the number of ports is 6, the comb structure size is 8, and the CS mapping method 14 is used, the corresponding comb position mapping method 17 is as follows:

Optionally, six ports for the first SRS are divided into two groups, comb positions mapped by ports in a same group are the same, and ports in different groups are mapped to different comb positions, that is, ports {1001, 1003, 1005} are mapped to a same first comb position, and ports {1000, 1002, 1004} are mapped to a same second comb position. The first comb position and the second comb position are different.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 8, a CS mapping method 15 is as follows:

Six ports for the first SRS are divided into two groups, ports in the same group use a same CS, and ports in different groups use different CSs, that is, ports {1000, 1001, 1002} are one group and use a same CS, and ports {1003, 1004, 1005} are one group and use a same CS.

A CS of a sequence mapped by the ports for the first SRS is obtained through calculation by using the following formula:

$${n}_{SRS}^{cs , i} = [ {n}_{SRS}^{c s} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=3.

For the CS mapping method 15, CS values corresponding to ports are shown in Table 15.

TABLE 15
CS values corresponding to ports

| | 1000 | 1001 | 1002 | 1003 | 1004 | 1005 |
|---|---|---|---|---|---|---|
| Initial CS 0 | 0 | 0 | 0 | 3 | 3 | 3 |
| Initial CS 1 | 1 | 1 | 1 | 4 | 4 | 4 |
| Initial CS 2 | 2 | 2 | 2 | 5 | 5 | 5 |
| Initial CS 3 | 3 | 3 | 3 | 0 | 0 | 0 |
| Initial CS 4 | 4 | 4 | 4 | 1 | 1 | 1 |
| Initial CS 5 | 5 | 5 | 5 | 2 | 2 | 2 |

Optionally, in a case that the number of ports is 6, the comb structure size is 8, and the CS mapping method 15 is used, the corresponding comb position mapping method 18 is as follows:

Six ports for the first SRS are divided into three groups, comb positions mapped by ports in a same group are the same, and ports in different groups are mapped to different comb positions, that is, ports {1000, 1003} are mapped to a same first comb position, ports {1000, 1004} are mapped to a same second comb position, and ports {1002, 1005} are mapped to a same third comb position. The first comb position, the second comb position, and the third comb position are different.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix}$$

$$or$$

$${k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 10 \; 04 \} \\ ( {\overline{k}}_{TC} + {n}_{3} ) mod {K}_{TC} & if {p}_{i} ∈ \{ 1002 , 1005 \}\end{matrix} ,$$

where
k_{TC}^{(p}^{ᵢ}⁾ is a comb position mapped by port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

Optionally, n₁=3 and n₂=6.

Optionally, n₁=0, n₂=3, and n₃=6.

This embodiment of this application provides the CS mapping method and comb position mapping method used for a case that the number of ports for SRSs is 6 and the comb structure size is 8, which can be used to improve the orthogonality of SRS reference signal transmission on the ports, and improve the performance of uplink transmission.

The execution subject of the port mapping method for sounding reference signals provided in the embodiments of this application may be a port mapping apparatus for sounding reference signals. In the embodiments of this application, the port mapping apparatus for sounding reference signals provided in the embodiments of this application is described by using the port mapping method for sounding reference signals being executed by the port mapping apparatus for sounding reference signals as an example.

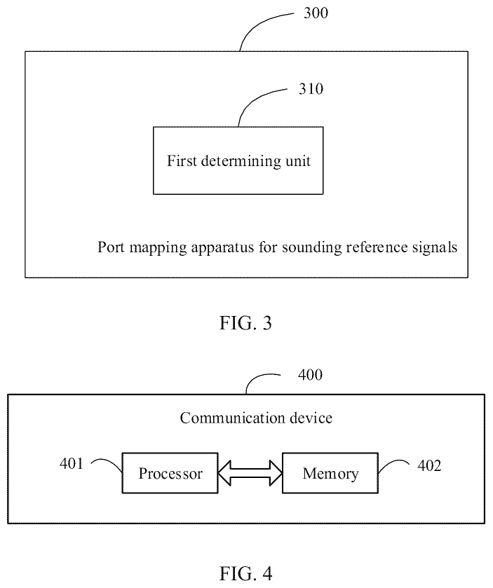

FIG. 3 is a schematic flowchart of a port mapping apparatus for sounding reference signals according to an embodiment of this application. As shown in FIG. 3, the apparatus 300 includes:
a first determining unit 310, configured to: in a case that the number of ports for a first sounding reference signal SRS is 6 or 8, determine, for a terminal, a cyclic shift CS corresponding to each port for the first SRS and/or a comb position mapped by the each port for the first SRS; where
a comb structure size of the first SRS is N, and N is 2, 4, 6, or 8.

Optionally, the CS corresponding to the each port for the first SRS is determined based on at least one of a cyclic shift offset value, a maximum cyclic shift offset value, a first parameter, a comb structure size, a port number, or the number of ports; and/or
a comb position mapped by the each port for the first SRS is determined based on at least one of a comb offset value, a comb structure size, a cyclic shift offset value, a maximum cyclic shift offset value, a first parameter, or a port number.

Optionally, in a case that the number of ports is 8 and a comb structure size is 2, different ports for the first SRS correspond to different CSs, and a CS corresponding to the each port for the first SRS is obtained through calculation by using the following formula:

$${n}_{SRS}^{cs , i} = [ {n}_{SRS}^{c s} + \frac{{n}_{SRS}^{cs , max} ( {p}_{i} - 1000 )}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, the each port for the first SRS is mapped to a same comb position, and a comb position mapped by the each port for the first SRS is obtained through calculation by using the following formula:

k_{TC}^{(p}^{ᵢ}⁾=k̅_{TC}, where
k_{TC}^{(p}^{ᵢ}⁾ is a comb position mapped by port i, and k̅_{TC} is the comb offset value.

Optionally, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 , 1007 \} \\ {\overline{k}}_{T C} & othe r w i s e\end{matrix}$$

$$or$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 , 1006 \} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, the comb position mapped by the each port for the first SRS is related to the cyclic shift offset value; and for a specific cyclic shift offset value, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 10 \; 01 , 1003 , 1005 , 1007 \}\end{matrix} \\ {\overline{k}}_{T C} & othe r w i s e\end{matrix}$$

$$or$$

$${k}_{T C}^{( {p}_{i} )} = \{ \begin{matrix}( {\overline{k}}_{T C} + {K}_{T C} / 2 ) mod {K}_{T C} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 10 \; 00 , 1002 , 1004 , 1006 \}\end{matrix} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 2, eight ports for the first SRS are divided into four groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between a network-side device and the terminal and/or a value indicated by the network-side device and/or a value reported by the terminal, and x=2.

Optionally, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 , 1007 \} \\ {\overline{k}}_{T C} & othe r w i s e\end{matrix}$$

$$or$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 , 1006 \} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 4, eight ports for the first SRS are divided into four groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs . max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

Optionally, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 , 1007 \} \\ {\overline{k}}_{T C} & othe r w i s e\end{matrix}$$

$$or$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 , 1006 \} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, the comb position mapped by the each port for the first SRS is related to the cyclic shift offset value.

A comb position mapped by the each port for the first SRS is obtained through calculation by using the following formula:

$${k}_{TC}^{( {p}_{i} )} = \{ \begin{matrix}( {\overline{k}}_{TC} + 1 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1005 \}\end{matrix} \\ ( {\overline{k}}_{TC} + 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1002 , 1006 \}\end{matrix} \\ ( {\overline{k}}_{TC} + 3 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1003 , 1007 \}\end{matrix} \\ ( {\overline{k}}_{TC} + {K}_{TC} / 2 ) mod {K}_{TC} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}\begin{matrix}( {\overline{k}}_{TC} + ( {p}_{i} - 1000 ) mod {K}_{TC} ) \\ mod {K}_{TC}\end{matrix} & if {n}_{SRS}^{cs} ∈ \{ {n}_{SRS}^{cs , max} / 2 , … , {n}_{SRS}^{cs , max} - 1 \} \\ ( {\overline{k}}_{TC} + {K}_{TC} / 2 ) mod {K}_{TC} & \begin{matrix}if {n}_{SRS}^{cs} ∉ \{ {n}_{SRS}^{cs , max} / 2 , … , {n}_{SRS}^{cs , max} - 1 \} \\ and {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}\begin{matrix}( {\overline{k}}_{TC} + ( {p}_{i} - 1000 ) mod 4 ) \\ mod {K}_{TC}\end{matrix} & if {n}_{SRS}^{cs} ∈ \{ {n}_{SRS}^{cs , max} / 2 , … , {n}_{SRS}^{cs , max} - 1 \} \\ ( {\overline{k}}_{TC} + {K}_{TC} / 2 ) mod {K}_{TC} & \begin{matrix}if {n}_{SRS}^{cs} ∉ \{ {n}_{SRS}^{cs , max} / 2 , … , {n}_{SRS}^{cs , max} - 1 \} \\ and {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}( {\overline{k}}_{TC} + 1 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1002 , 1006 \}\end{matrix} \\ ( {\overline{k}}_{TC} + 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1005 \}\end{matrix} \\ ( {\overline{k}}_{TC} + 3 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1003 , 1007 \}\end{matrix} \\ ( {\overline{k}}_{TC} + {K}_{TC} / 2 ) mod {K}_{TC} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 - 1 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1002 , 1006 \}\end{matrix} \\ ( {\overline{k}}_{TC} + 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1005 \}\end{matrix} \\ ( {\overline{k}}_{TC} + {K}_{TC} / 2 + 1 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1003 , 1007 \}\end{matrix} \\ ( {\overline{k}}_{TC} + {K}_{TC} / 2 ) mod {K}_{TC} & \begin{matrix}if {n}_{SRS}^{cs} ∉ \{ {n}_{SRS}^{cs , max} / 2 , … , {n}_{SRS}^{cs , max} - 1 \} and \\ {p}_{i} ∈ \{ 1001 , 1003 , 1005 , 1007 \}\end{matrix} \\ {\overline{k}}_{TC} & otherwise\end{matrix}$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 4, eight ports for the first SRS are divided into two groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{c s} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max}$$

$$or$$

$${n}_{SRS}^{cs , i} = [ {n}_{SRS}^{c s} + \frac{{n}_{SRS}^{cs , max} \cdot ⌊ ( {p}_{i} - 10 \; 00 ) / {K}_{T C} ⌋ \cdot {K}_{T C} ⌋}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, x is the first parameter, x is a value agreed by default between the network-side device and the terminal and/or a value indicated by the network-side device and/or a value reported by the terminal, x=4, and K_{TC} is the comb structure size.

Optionally, eight ports for the first SRS are divided into four groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 10 \; 00 , 1004 \} \\ ( {\overline{k}}_{TC} + 1 ) mod {K}_{TC} & if {p}_{i} ∈ \{ 10 \; 01 , 1005 \} \\ ( {\overline{k}}_{TC} + 2 ) mod {K}_{T C} & if {p}_{i} ∈ \{ 10 \; 02 , 1006 \} \\ ( {\overline{k}}_{TC} + 3 ) mod {K}_{TC} & if {p}_{i} ∈ \{ 10 \; 03 , 1007 \}\end{matrix}$$

$$or$$

$${k}_{TC}^{( {p}_{i} )} = ( {\overline{k}}_{TC} + ( {p}_{i} - 1000 ) mod {K}_{TC} ) mod {K}_{TC}$$

$$or$$

$${k}_{TC}^{( {p}_{i} )} = ( {\overline{k}}_{TC} + ( {p}_{i} - 10 \; 00 ) mod 4 ) mod {K}_{TC}$$

$$or$$

$${k}_{TC}^{( {p}_{i} )} = ( {\overline{k}}_{TC} + ( {p}_{i} - 10 \; 00 ) mod x ) mod {K}_{TC} ,$$

where
k_{TC}^{(p}^{ᵢ}⁾ is a comb position mapped by port i, and k̅_{TC} is the comb offset value.

Optionally, in a case that the number of ports is 8 and the comb structure size is 8, eight ports for the first SRS are divided into two groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=4.

Optionally, eight ports for the first SRS are divided into four groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 10 \; 00 , 1004 \} \\ ( {\overline{k}}_{TC} + 2 ) mod {K}_{TC} & if {p}_{i} ∈ \{ 10 \; 01 , 1005 \} \\ ( {\overline{k}}_{TC} + 4 ) mod {K}_{T C} & if {p}_{i} ∈ \{ 10 \; 02 , 1006 \} \\ ( {\overline{k}}_{TC} + 6 ) mod {K}_{TC} & if {p}_{i} ∈ \{ 10 \; 03 , 1007 \}\end{matrix}$$

$$or$$

$${k}_{TC}^{( {p}_{i} )} = ( {\overline{k}}_{TC} + ( 2 ( {p}_{i} - 1000 ) ) mod 4 ) mod {K}_{TC}$$

$$or$$

$${k}_{TC}^{( {p}_{i} )} = ( {\overline{k}}_{TC} + ( 8 / x \cdot ( {p}_{i} - 10 \; 00 ) ) mod x ) mod {K}_{TC} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 8, all eight ports for the first SRS use a same CS.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 10 \; 00 ) / x ⌋ \cdot x}{{N}_{ap}^{SRS}} ] mod {n}_{SRS}^{cs , max}$$

or
n_{SRS}^{cs,i}=n_{SRS}^{cs}, where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=8.

Optionally, different ports for the first SRS are mapped to different comb positions.

A comb position mapped by the each port for the first SRS is obtained through calculation by using the following formula:

$${k}_{T C}^{( {p}_{i} )} = \{ \begin{matrix}{\overline{k}}_{T C} & if {p}_{i} ∈ \{ 1000 \} \\ ( {\overline{k}}_{T C} + 1 ) mod {K}_{T C} & if {p}_{i} ∈ \{ 1001 \} \\ ( {\overline{k}}_{T C} + 2 ) mod {K}_{T C} & if {p}_{i} ∈ \{ 1002 \} \\ ( {\overline{k}}_{T C} + 3 ) mod {K}_{T C} & if {p}_{i} ∈ \{ 1003 \} \\ ( {\overline{k}}_{T C} + 4 ) mod {K}_{T C} & if {p}_{i} ∈ \{ 1004 \} \\ ( {\overline{k}}_{T C} + 5 ) mod {K}_{T C} & if {p}_{i} ∈ \{ 1005 \} \\ ( {\overline{k}}_{T C} + 6 ) mod {K}_{T C} & if {p}_{i} ∈ \{ 1006 \} \\ ( {\overline{k}}_{T C} + 7 ) mod {K}_{T C} & if {p}_{i} ∈ \{ 1007 \}\end{matrix}$$

$$or$$

$${k}_{T C}^{( {p}_{i} )} = ( {\overline{k}}_{T C} + {p}_{i} - 10 \; 00 ) mod {K}_{T C}$$

$$or$$

$${k}_{T C}^{( p )} = ( {\overline{k}}_{T C} + ( 8 / x \cdot ( {p}_{i} - 1000 ) ) mod x ) mod {K}_{T C} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = [ {n}_{SRS}^{c s} + ⌊ \frac{{n}_{SRS}^{cs , max} ( {p}_{i} - 1000 )}{{N}_{ap}^{SRS}} ⌋ ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1003 , 1005 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1004 \} \\ {\overline{k}}_{T C} & otherwise\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 \} \\ {\overline{k}}_{T C} & otherwise\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 \} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that a comb position mapped by the each port for the first SRS is obtained through calculation by using the following formula:

$${k}_{TC}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1003 , 1005 \} \\ {\overline{k}}_{TC} & othe r w i s e\end{matrix} ,$$

a port for a second SRS and ports {1001, 1004} for the first SRS are mapped to a same comb position, and a cyclic shift offset value corresponding to the second SRS is equal to a value obtained by performing remainder calculation on a maximum cyclic shift offset value corresponding to the first SRS after adding 3 to a cyclic shift offset value corresponding to the first SRS.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{T C} & if {p}_{i} ∈ \{ 10 \; 01 , 1004 \} \\ {\overline{k}}_{TC} & othe r w i s e\end{matrix} ,$$

a port for a second SRS and ports {1001, 1004} for the first SRS are mapped to a same comb position, and a cyclic shift offset value corresponding to the second SRS is equal to a value obtained by performing remainder calculation on a maximum cyclic shift offset value corresponding to the first SRS after adding 3 to a cyclic shift offset value corresponding to the first SRS.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = [ {n}_{SRS}^{c s} + ⌈ \frac{{n}_{SRS}^{cs , max} ( {p}_{i} - 1000 )}{{N}_{ap}^{SRS}} ⌉ ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1001 , 1003 , 1004 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 02 , 1005 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 \} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that a comb position mapped by the each port for the first SRS is obtained through calculation by using the following formula:

$${k}_{TC}^{( {p}_{i} )} = \{ \begin{matrix}( {\overline{k}}_{T C} + {K}_{T C} / 2 ) mod {K}_{T C} & if {p}_{i} ∈ \{ 1000 , 1001 , 1003 , 1004 \} \\ {\overline{k}}_{T C} & othe r w i s e\end{matrix}$$

a port for a third SRS and ports {1002, 1005} for the first SRS are mapped to a same comb position, and a cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

Optionally, in a case that a comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 02 , 1005 \} \\ {\overline{k}}_{T C} & othe r w i s e\end{matrix} ,$$

a port for a third SRS and ports {1002, 1005} for the first SRS are mapped to a same comb position, and a cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = \{ \begin{matrix}[ {n}_{S R S}^{c s} + ⌊ \frac{{n}_{SRS}^{cs , max} ( {p}_{i} - 1000 )}{{N}_{ap}^{SRS}} ⌋ ] mod {n}_{SRS}^{cs , max} & if {p}_{i} ∈ \{ 10 \; 01 , 1004 \} \\ [ {n}_{S R S}^{c s} + ⌈ \frac{{n}_{SRS}^{cs , max} ( {p}_{i} - 1000 )}{{N}_{ap}^{SRS}} ⌉ ] mod {n}_{SRS}^{cs , max} & if {p}_{i} ∈ \{ 10 \; 02 , 1005 \} , wher e \\ [ {n}_{SRS}^{c s} + \frac{{n}_{SRS}^{cs , max} ( {p}_{i} - 1000 )}{{N}_{ap}^{SRS}} ] mod {n}_{SRS}^{cs , max} & otherwise\end{matrix}$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1002 , 1004 , 1005 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1003 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 \} \\ {\overline{k}}_{T C} & othe r w i s e\end{matrix} or ,$$

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1003 , 1005 \} \\ {\overline{k}}_{T C} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that a comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1002 , 1004 , 1005 \} \\ {\overline{k}}_{T C} & othe r w i s e\end{matrix} ,$$

a port for a fourth SRS and ports {1000, 1003} for the first SRS are mapped to a same comb position, and a cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

Optionally, in a case that a comb position mapped by the each port for the first SRS is obtained through calculation by using the following formula:

$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1003 \} \\ {\overline{k}}_{T C} & othe r w i s e\end{matrix} ,$$

a port for a fourth SRS and ports {1000, 1003} for the first SRS are mapped to a same comb position, and a cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = \{ \text{} \begin{matrix}\begin{matrix}[ {n}_{S R S}^{c s} + ⌊ \frac{{n}_{SRS}^{cs , max} ( {p}_{i} - 1000 )}{{N}_{ap}^{SRS}} ⌋ ] \\ mod {n}_{SRS}^{cs , max}\end{matrix} & if {p}_{i} ∈ \{ 1001 \} \\ \begin{matrix}[ {n}_{S R S}^{c s} + ⌈ \frac{{n}_{SRS}^{cs , max} ( {p}_{i} - 1000 )}{{N}_{ap}^{SRS}} ⌉ ] \\ mod {n}_{SRS}^{cs , max}\end{matrix} & if {p}_{i} ∈ \{ 1 \; 002 , 1004 , 1005 \} , wher e \\ \begin{matrix}[ {n}_{SRS}^{c s} + \frac{{n}_{SRS}^{cs , max} ( {p}_{i} - 1000 )}{{N}_{ap}^{SRS}} ] \\ mod {n}_{SRS}^{cs , max}\end{matrix} & otherwise\end{matrix}$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{T C} + {K}_{T C} / 2 ) mod {K}_{T C} & if {p}_{i} ∈ \{ 1000 , 1002 , 1004 \} \\ {\overline{k}}_{TC} & othe r w i s e\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 10 \; 01 , 1003 , 1005 \} \\ {\overline{k}}_{TC} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 4, different ports for the first SRS use different CSs, and
a CS corresponding to the each port for the first SRS is obtained through calculation by using the following formula:

$${n}_{SRS}^{cs , i} = [ {n}_{SRS}^{cs} + \frac{{n}_{SRS}^{cs , max} ( {p}_{i} - 1000 )}{{N}_{a p}^{SRS}} ] mod {n}_{SRS}^{cs , max} ,$$

where,
c_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, the comb position mapped by the each port for the first SRS is related to the cyclic shift offset value; and for a specific cyclic shift offset value, six ports for the first SRS are divided into two groups, comb positions mapped by ports in a same group are the same, and ports in different groups are mapped to different comb positions. A comb position mapped by the each port for the first SRS is obtained through calculation by using the following formula:

$${k}_{TC}^{( {p}_{i} )} = \{ \begin{matrix}( {\overline{k}}_{T C} + {K}_{T C} / 2 ) mod {K}_{T C} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1003 , 1005 \}\end{matrix} \\ {\overline{k}}_{TC} & othe r w i s e\end{matrix}$$

$$or$$

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1000 , 1002 , 1004 \}\end{matrix} \\ {\overline{k}}_{TC} & othe r w i s e\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 6, six ports for the first SRS are divided into two groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=3.

Optionally, six ports for the first SRS are divided into three groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix}$$

$$or$$

$${k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 1004 \} \\ ( {\overline{k}}_{TC} + {n}_{3} ) mod {K}_{TC} & if {p}_{i} ∈ \{ 1002 , 1005 \}\end{matrix} ,$$

where
k_{TC}^{(p}^{ᵢ}⁾ is a comb position mapped by port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

Optionally, in a case that the number of ports is 6 and the comb structure size is 8, different ports for the first SRS use different CSs, and
a CS corresponding to the each port for the first SRS is obtained through calculation by using the following formula:

$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, the comb position mapped by the each port for the first SRS is related to the cyclic shift offset value; and for a specific cyclic shift offset value, six ports for the first SRS are divided into two groups, comb positions mapped by ports in a same group are the same, and ports in different groups are mapped to different comb positions. A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1003 , 1005 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1000 , 1002 , 1004 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 8, six ports for the first SRS are divided into three groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 8, six ports for the first SRS are divided into two groups, ports in a same group uses a same CS, and ports in different groups use different CSs.

A CS of a sequence mapped by the ports for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=3.

Optionally, six ports for the first SRS are divided into three groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix}$$

$$or$$

$${k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 1004 \} \\ ( {\overline{k}}_{TC} + {n}_{3} ) mod {K}_{TC} & if {p}_{i} ∈ \{ 1002 , 1005 \}\end{matrix} ,$$

where
k_{TC}^{(p}^{ᵢ}⁾ is a comb position mapped by port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

This embodiment of this application provides a port mapping solution used for cases that different combs are configured for SRSs when the number of ports for SRSs is 6 and 8, which can improve the orthogonality of SRS reference signal transmission on each port, thereby improving performance of uplink transmission.

The port mapping apparatus for sounding reference signals in this embodiment of this application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a network attached storage (NAS), and the like. This is not limited in the embodiments of this application.

The port mapping apparatus for sounding reference signals provided in this embodiment of this application is capable of implementing the processes implemented in the method embodiments in FIG. 2, with the same technical effects achieved. To avoid repetition, details are not described herein again.

Optionally, as shown in FIG. 4, an embodiment of this application further provides a communication device 400, including a processor 401, a memory 402, and a program or instructions stored in the memory 402 and executable on the processor 401. For example, when the communication device 400 is a terminal and when the program or the instructions are executed by the processor 401, the steps of the foregoing embodiments of the port mapping method for sounding reference signals are implemented, with the same technical effects achieved. When the communication device 400 is a network-side device and when the program or the instructions are executed by the processor 401, the steps of the foregoing embodiments of the port mapping method for sounding reference signals are implemented, with the same technical effects achieved. To avoid repetition, details are not described herein again.

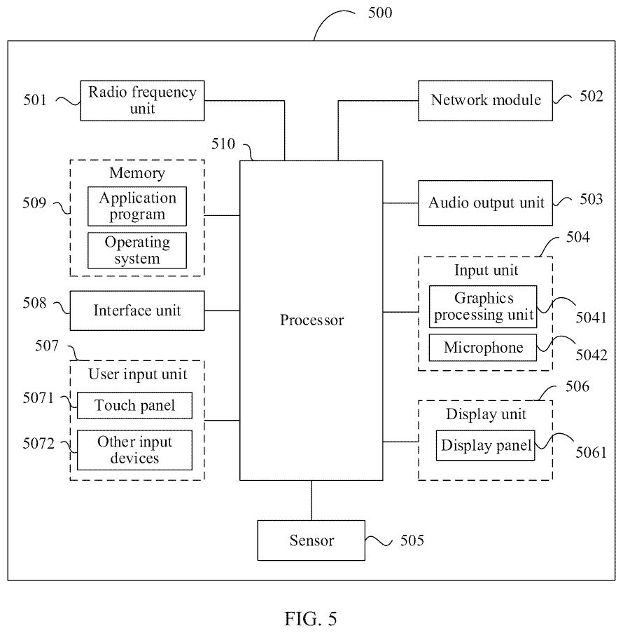

An embodiment of this application further provides a terminal, including a processor and a communication interface, where the processor is configured to: in a case that the number of ports for a first sounding reference signal SRS is 6 or 8, determine a cyclic shift CS corresponding to each port for the first SRS and/or a comb position mapped by the each port for the first SRS; where a comb structure size of the first SRS is N, and N is 2, 4, 6, or 8. The terminal embodiments correspond to the foregoing terminal-side method embodiments, and the implementation processes and implementations of the foregoing method embodiments can be applied to the terminal embodiments, with the same technical effects achieved. Optionally, FIG. 5 is a schematic diagram of a hardware structure of a terminal for implementing the embodiments of this application.

The terminal 500 includes but is not limited to at least part of components such as a radio frequency unit 501, a network module 502, an audio output unit 503, an input unit 504, a sensor 505, a display unit 506, a user input unit 507, an interface unit 508, a memory 509, and a processor 510.

Persons skilled in the art can understand that the terminal 500 may further include a power supply (for example, a battery) supplying power to the components, and the power supply may be logically connected to the processor 510 through a power management system. In this way, functions such as charge management, discharge management, and power consumption management are implemented by using the power management system. The structure of the terminal shown in FIG. 5 does not constitute any limitation on the terminal. The terminal may include more or fewer components than shown in the figure, or a combination of some components, or the components disposed differently. Details are not described herein again.

It can be understood that in this embodiment of this application, the input unit 504 may include a graphics processing unit (GPU) 5041 and a microphone 5042. The graphics processing unit 5041 processes image data of a still picture or video obtained by an image capture apparatus (such as a camera) in a video capture mode or an image capture mode. The display unit 506 may include a display panel 5061, and the display panel 5061 may be configured in a form of a liquid crystal display, an organic light-emitting diode, and the like. The user input unit 507 may include at least one of a touch panel 5071 or other input devices 5072. The touch panel 5071 is also referred to as a touchscreen. The touch panel 5071 may include two parts: a touch detection apparatus and a touch controller. The other input devices 5072 may include but are not limited to a physical keyboard, a function key (such as a volume control key or a power on/off key), a trackball, a mouse, a joystick, and the like. Details are not described herein.

In this embodiment of this application, the radio frequency unit 501 receives downlink data from a network-side device, and then sends the downlink data to the processor 510 for processing. In addition, the radio frequency unit 501 may send uplink data to the network-side device. Generally, the radio frequency unit 501 includes but is not limited to an antenna, an amplifier, a transceiver, a coupler, a low noise amplifier, a duplexer, and the like.

The memory 509 may be configured to store software programs or instructions and various data. The memory 509 may include a first storage area for storing a program or instructions and a second storage area for storing data. The first storage area may store an operating system, an application program or instruction required by at least one function (for example, a sound playback function or an image playback function), and the like. In addition, the memory 509 may include a volatile memory or a non-volatile memory, or the memory 509 may include both a volatile memory and a non-volatile memory. The non-volatile memory may be a read-only memory (ROM), a programmable read only memory (PROM), an erasable programmable read-only memory (EPROM), and an electrically erasable programmable read-only memory (EEPROM), or flash memory. The volatile memory can be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 509 in the embodiments of this application includes but is not limited to these and any other suitable types of memories.

The processor 510 may include one or more processing units. Optionally, an application processor and a modem processor may be integrated in the processor 510. This application processor primarily processes operations involving an operating system, user interfaces, application programs, and the like. The modem processor primarily processes radio communication signals, for example, being a baseband processor. It can be understood that the modem processor may alternatively be not integrated in the processor 510.

The processor 510 is configured to: in a case that the number of ports for a first sounding reference signal SRS is 6 or 8, determine a cyclic shift CS corresponding to each port for the first SRS and/or a comb position mapped by the each port for the first SRS; where a comb structure size of the first SRS is N, and N is 2, 4, 6, or 8. Optionally, the CS corresponding to the each port for the first SRS is determined based on at least one of a cyclic shift offset value, a maximum cyclic shift offset value, a first parameter, a comb structure size, a port number, or the number of ports; and/or
a comb position mapped by the each port for the first SRS is determined based on at least one of a comb offset value, a comb structure size, a cyclic shift offset value, a maximum cyclic shift offset value, a first parameter, or a port number.

Optionally, in a case that the number of ports is 8 and a comb structure size is 2, different ports for the first SRS correspond to different CSs, and a CS corresponding to the each port for the first SRS is obtained through calculation by using the following formula:

$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, the each port for the first SRS is mapped to a same comb position, and a comb position mapped by the each port for the first SRS is obtained through calculation by using the following formula:

k_{TC}^{(p}^{ᵢ}⁾=k̅_{TC}, where
k_{TC}^{(p}^{ᵢ}⁾ is a comb position mapped by port i, and k̅_{TC} is the comb offset value.

Optionally, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 , 1006 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, the comb position mapped by the each port for the first SRS is related to the cyclic shift offset value; and for a specific cyclic shift offset value, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1000 , 1002 , 1004 , 1006 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 2, eight ports for the first SRS are divided into four groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{STS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

Optionally, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 , 1006 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 4, eight ports for the first SRS are divided into four groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

Optionally, eight ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 , 1006 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, the comb position mapped by the each port for the first SRS is related to the cyclic shift offset value.
a comb position mapped by the each port for the first SRS is obtained through calculation by using the following formula:

$${k}_{TC}^{( {p}_{i} )} = \{ \begin{matrix}( {\overline{k}}_{TC} + 1 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1005 \} \\ ( {\overline{k}}_{TC} + 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1002 , 1006 \} \\ ( {\overline{k}}_{TC} + 3 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1003 , 1007 \} \\ ( {\overline{k}}_{TC} + {K}_{TC} / 2 ) mod {K}_{TC} & if {n}_{SRS}^{cs} ∉ \{ {n}_{SRS}^{cs , max} / 2 , ... , {n}_{SRS}^{cs , max} - 1 \} and {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + ( {p}_{i} - 1000 ) mod {K}_{TC} ) mod {K}_{TC} & if {n}_{SRS}^{cs} ∈ \{ {n}_{SRS}^{cs , max} / 2 , ... , {n}_{SRS}^{cs , max} - 1 \} \\ ( {\overline{k}}_{TC} + {K}_{TC} / 2 ) mod {K}_{TC} & if {n}_{SRS}^{cs} ∉ \{ {n}_{SRS}^{cs , max} / 2 , ... , {n}_{SRS}^{cs , max} - 1 \} and {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + ( {p}_{i} - 1000 ) mod 4 ) mod {K}_{TC} & if {n}_{SRS}^{cs} ∈ \{ {n}_{SRS}^{cs , max} / 2 , ... , {n}_{SRS}^{cs , max} - 1 \} \\ ( {\overline{k}}_{TC} + {K}_{TC} / 2 ) mod {K}_{TC} & if {n}_{SRS}^{cs} ∉ \{ {n}_{SRS}^{cs , max} / 2 , ... , {n}_{SRS}^{cs , max} - 1 \} and {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + 1 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1002 , 1006 \} \\ ( {\overline{k}}_{TC} + 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1005 \} \\ ( {\overline{k}}_{TC} + 3 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1003 , 1007 \} \\ ( {\overline{k}}_{TC} + {K}_{TC} / 2 ) mod {K}_{TC} & if {n}_{SRS}^{cs} ∉ \{ {n}_{SRS}^{cs , max} / 2 , ... , {n}_{SRS}^{cs , max} - 1 \} and {p}_{i} ∈ \{ 1001 , 1003 , 1005 , 1007 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 - 1 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1002 , 1006 \} \\ ( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1005 \} \\ ( {\overline{k}}_{TC} + {K}_{TC} / 2 + 1 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1003 , 1007 \} \\ ( {\overline{k}}_{TC} + {K}_{TC} / 2 ) mod {K}_{TC} & if {n}_{SRS}^{cs} ∉ \{ {n}_{SRS}^{cs , max} / 2 , ... , {n}_{SRS}^{cs , max} - 1 \} and {p}_{i} ∈ \{ 1001 , 1003 , 1005 , 1007 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 4, eight ports for the first SRS are divided into two groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max}$$

$$or$$

$${n}_{SRS}^{cs , i} = [ {n}_{SRS}^{cs} + \frac{{n}_{SRS}^{cs , max} \cdot ⌊ ( {p}_{i} - 1000 ) / {K}_{TC} ⌋ \cdot {K}_{TC}}{{N}_{ap}^{SRS}} ] mod {n}_{SRS}^{cs , max} ,$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, x is the first parameter, x is a value agreed by default between the network-side device and the terminal and/or a value indicated by the network-side device and/or a value reported by the terminal, x=4, and Krc is the comb structure size.

Optionally, eight ports for the first SRS are divided into four groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1004 \} \\ ( {\overline{k}}_{TC} + 1 ) mod {K}_{TC} & if {p}_{i} ∈ \{ 1001 , 1005 \} \\ ( {\overline{k}}_{TC} + 2 ) mod {K}_{TC} & if {p}_{i} ∈ \{ 1002 , 1006 \} \\ ( {\overline{k}}_{TC} + 3 ) mod {K}_{TC} & if {p}_{i} ∈ \{ 1003 , 1007 \}\end{matrix}$$

$$or$$

$${k}_{TC}^{( {p}_{i} )} = ( {\overline{k}}_{TC} + ( {p}_{i} - 1000 ) mod {K}_{TC} ) mod {K}_{TC}$$

$$or$$

$${k}_{TC}^{( {p}_{i} )} = ( {\overline{k}}_{TC} + ( {p}_{i} - 1000 ) mod 4 ) mod {K}_{TC}$$

$$or$$

$${k}_{TC}^{( {p}_{i} )} = ( {\overline{k}}_{TC} + ( {p}_{i} - 1000 ) mod x ) mod {K}_{TC} ,$$

where
k_{TC}^{(p}^{ᵢ}⁾ is a comb position mapped by port i, and k̅_{TC} is the comb offset value.

Optionally, in a case that the number of ports is 8 and the comb structure size is 8, eight ports for the first SRS are divided into two groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=4.

Optionally, eight ports for the first SRS are divided into four groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1004 \} \\ ( {\overline{k}}_{TC} + 2 ) mod {K}_{TC} & if {p}_{i} ∈ \{ 1001 , 1005 \} \\ ( {\overline{k}}_{TC} + 4 ) mod {K}_{TC} & if {p}_{i} ∈ \{ 1002 , 1006 \} \\ ( {\overline{k}}_{TC} + 6 ) mod {K}_{TC} & if {p}_{i} ∈ \{ 1003 , 1007 \}\end{matrix}$$

$$or$$

$${k}_{TC}^{( {p}_{i} )} = ( {\overline{k}}_{TC} + ( 2 ( {p}_{i} - 1000 ) ) mod 4 ) mod {K}_{TC}$$

$$or$$

$${k}_{TC}^{( {p}_{i} )} = ( {\overline{k}}_{TC} + ( 8 / x \cdot ( {p}_{i} - 1000 ) ) mod x ) mod {K}_{TC} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 8 and the comb structure size is 8, all eight ports for the first SRS use a same CS.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max}$$

or
n_{SRS}^{cs,i}=n_{SRS}^{cs}, where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=8.

Optionally, different ports for the first SRS are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 \} \\ ( {\overline{k}}_{TC} + 1 ) mod {K}_{TC} & if {p}_{i} ∈ \{ 1001 \} \\ ( {\overline{k}}_{TC} + 2 ) mod {K}_{TC} & if {p}_{i} ∈ \{ 1002 \} \\ ( {\overline{k}}_{TC} + 3 ) mod {K}_{TC} & if {p}_{i} ∈ \{ 1003 \} \\ ( {\overline{k}}_{TC} + 4 ) mod {K}_{TC} & if {p}_{i} ∈ \{ 1004 \} \\ ( {\overline{k}}_{TC} + 5 ) mod {K}_{TC} & if {p}_{i} ∈ \{ 1005 \} \\ ( {\overline{k}}_{TC} + 6 ) mod {K}_{TC} & if {p}_{i} ∈ \{ 1006 \} \\ ( {\overline{k}}_{TC} + 7 ) mod {K}_{TC} & if {p}_{i} ∈ \{ 1007 \}\end{matrix}$$

$$or$$

$${k}_{TC}^{( {p}_{i} )} = ( {\overline{k}}_{TC} + {p}_{i} - 1000 ) mod {K}_{TC}$$

$$or$$

$${k}_{TC}^{( {p}_{i} )} = ( {\overline{k}}_{TC} + ( 8 / x \cdot ( {p}_{i} - 1000 ) ) mod x ) mod {K}_{TC} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = [ {n}_{SRS}^{cs} + ⌊ \frac{{n}_{SRS}^{cs , max} ( {p}_{i} - 1000 )}{{N}_{ap}^{SRS}} ⌋ ] mod {n}_{SRS}^{cs , max} ,$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1003 , 1005 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1004 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1003 , 1005 \} \\ {\overline{k}}_{TC} & otherwise\end{matrix}$$

a port for a second SRS and ports {1001, 1004} for the first SRS are mapped to a same comb position, and a cyclic shift offset value corresponding to the second SRS is equal to a value obtained by performing remainder calculation on a maximum cyclic shift offset value corresponding to the first SRS after adding 3 to a cyclic shift offset value corresponding to the first SRS.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1004 \} \\ {\overline{k}}_{TC} & otherwise\end{matrix} ,$$

a port for a second SRS and ports {1001, 1004} for the first SRS are mapped to a same comb position, and a cyclic shift offset value corresponding to the second SRS is equal to a value obtained by performing remainder calculation on a maximum cyclic shift offset value corresponding to the first SRS after adding 3 to a cyclic shift offset value corresponding to the first SRS.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = [ {n}_{SRS}^{cs} + ⌈ \frac{{n}_{SRS}^{cs , max} ( {p}_{i} - 1000 )}{{N}_{ap}^{SRS}} ⌉ ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1001 , 1003 , 1004 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1002 , 1005 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1001 , 1003 , 1004 \} \\ {\overline{k}}_{TC} & otherwise\end{matrix} ,$$

a port for a third SRS and ports {1002, 1005} for the first SRS are mapped to a same comb position, and a cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1002 , 1005 \} \\ {\overline{k}}_{TC} & otherwise\end{matrix} ,$$

a port for a third SRS and ports {1002, 1005} for the first SRS are mapped to a same comb position, and a cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = \{ \begin{matrix}[ {n}_{SRS}^{cs} + ⌊ \frac{{n}_{SRS}^{cs , max} ( {p}_{i} - 1000 )}{{N}_{ap}^{SRS}} ⌋ ] mod {n}_{SRS}^{cs , max} & if {p}_{i} ∈ \{ 1001 , 1004 \} \\ [ {n}_{SRS}^{cs} + ⌈ \frac{{n}_{SRS}^{cs , max} ( {p}_{i} - 1000 )}{{N}_{ap}^{SRS}} ⌉ ] mod {n}_{SRS}^{cs , max} & if {p}_{i} ∈ \{ 1002 , 1005 \} \\ [ {n}_{SRS}^{cs} + \frac{{n}_{SRS}^{cs , max} ( {p}_{i} - 1000 )}{{N}_{ap}^{SRS}} ] mod {n}_{SRS}^{cs , max} & otherwise\end{matrix} , where$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1002 , 1004 , 1005 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1003 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix}$$

$$or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1002 , 1004 , 1005 \} \\ {\overline{k}}_{TC} & otherwise\end{matrix} ,$$

a port for a fourth SRS and ports {1000, 1003} for the first SRS are mapped to a same comb position, and a cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

Optionally, in a case that a comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1003 \} \\ {\overline{k}}_{TC} & otherwise\end{matrix} ,$$

a port for a fourth SRS and ports {1000, 1003} for the first SRS are mapped to a same comb position, and a cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

Optionally, in a case that the number of ports is 6 and the comb structure size is 2, different ports for the first SRS use different CSs, and
a CS corresponding to the each port for the first SRS is obtained through calculation by using the following formula:

$${n}_{SRS}^{cs , i} = \{ \begin{matrix}[ {n}_{SRS}^{cs} + ⌊ \frac{{n}_{SRS}^{cs , max} ( {p}_{i} - 1000 )}{{N}_{ap}^{SRS}} ⌋ ] mod {n}_{SRS}^{cs , max} & if {p}_{i} ∈ \{ 1001 \} \\ [ {n}_{SRS}^{cs} + ⌈ \frac{{n}_{SRS}^{cs , max} ( {p}_{i} - 1000 )}{{N}_{ap}^{SRS}} ⌉ ] mod {n}_{SRS}^{cs , max} & if {p}_{i} ∈ \{ 1002 , 1004 , 1005 \} \\ [ {n}_{SRS}^{cs} + \frac{{n}_{SRS}^{cs , max} ( {p}_{i} - 1000 )}{{N}_{ap}^{SRS}} ] mod {n}_{SRS}^{cs , max} & otherwise\end{matrix} , where$$

n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 4, different ports for the first SRS use different CSs, and
a CS corresponding to the each port for the first SRS is obtained through calculation by using the following formula:

$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, the comb position mapped by the each port for the first SRS is related to the cyclic shift offset value; and for a specific cyclic shift offset value, six ports for the first SRS are divided into two groups, comb positions mapped by ports in a same group are the same, and ports in different groups are mapped to different comb positions. A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1003 , 1005 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1000 , 1002 , 1004 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 6, six ports for the first SRS are divided into two groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=3.

Optionally, six ports for the first SRS are divided into three groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix}$$

$$or$$

$${k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 1004 \} \\ ( {\overline{k}}_{TC} + {n}_{3} ) mod {K}_{TC} & if {p}_{i} ∈ \{ 1002 , 1005 \}\end{matrix} ,$$

where
k_{TC}^{(p}^{ᵢ}⁾ is a comb position mapped by port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

Optionally, in a case that the number of ports is 6 and the comb structure size is 8, different ports for the first SRS use different CSs, and
a CS corresponding to the each port for the first SRS is obtained through calculation by using the following formula:

$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$

where,
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, and Nₐₚ^{SRS} is the number of ports.

Optionally, the comb position mapped by the each port for the first SRS is related to the cyclic shift offset value; and for a specific cyclic shift offset value, six ports for the first SRS are divided into two groups, comb positions mapped by ports in a same group are the same, and ports in different groups are mapped to different comb positions. A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1001 , 1003 , 1005 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , ... , {n}_{SRS}^{cs , max} - 1 \} and {p}_{i} ∈ \{ 1000 , 1002 , 1004 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 8, six ports for the first SRS are divided into three groups, ports in a same group uses a same CS, and ports in different groups use different CSs.

A CS corresponding to the each port for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=2.

Optionally, six ports for the first SRS are divided into two groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix}$$

$$or$$

$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix} ,$$

where
k_{TC}^{(p}^{ᵢ}⁾ is a comb position mapped by port i, k̅_{TC} is the comb offset value, and K_{TC} is the comb structure size.

Optionally, in a case that the number of ports is 6 and the comb structure size is 8, six ports for the first SRS are divided into two groups, ports in a same group uses a same CS, and ports in different groups use different CSs.

A CS of a sequence mapped by the ports for the first SRS is obtained through calculation by using the following formula:

$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$

where
n_{SRS}^{cs,i} is a CS corresponding to port i, n_{SRS}^{cs} is the cyclic shift offset value, n_{SRS}^{cs,max} is the maximum cyclic shift offset value, pᵢ is a port number, Nₐₚ^{SRS} is the number of ports, and x is the first parameter, where x is a value agreed by default between the network-side device and the terminal and/or a value indicated by the network-side device and/or a value reported by the terminal, and x=3.

Optionally, six ports for the first SRS are divided into three groups, comb positions mapped by ports in a same group are the same, and ports in different groups are mapped to different comb positions.

A comb position mapped by the each port for the first SRS is obtained through calculation by using the following formula:

$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix}$$

$$or$$

$${k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 1004 \} \\ ( {\overline{k}}_{TC} + {n}_{3} ) mod {K}_{TC} & if {p}_{i} ∈ \{ 1002 , 1005 \}\end{matrix} ,$$

where
k_{TC}^{(p}^{ᵢ}⁾ is a comb position mapped by port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

This embodiment of this application provides a port mapping solution used for cases that different combs are configured for SRSs when the number of ports for SRSs is 6 and 8, which can improve the orthogonality of SRS reference signal transmission on each port, thereby improving performance of uplink transmission.

An embodiment of this application further provides a non-transitory readable storage medium, where a program or instructions are stored in the non-transitory readable storage medium. When the program or the instructions are executed by a processor, the processes of the foregoing embodiments of the port mapping method for sounding reference signals described above can be implemented, with the same technical effects achieved. To avoid repetition, details are not described herein again.

The processor is a processor in the terminal described in the foregoing embodiments. The non-transitory readable storage medium includes a non-transitory computer-readable storage medium, for example, a computer read only memory ROM, a random access memory RAM, a magnetic disk, or an optical disc.

An embodiment of this application further provides a chip, where the chip includes a processor and a communication interface. The communication interface is coupled to the processor, and the processor is configured to run a program or an instruction to implement the processes of the foregoing embodiment of the port mapping method for sounding reference signals, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a non-transitory storage medium, and when being executed by at least one processor, the computer program/program product is configured to implement the processes of the foregoing embodiments of the port mapping method for sounding reference signals, with the same technical effects achieved. To avoid repetition, details are not repeated herein.

An embodiment of this application further provides a communications system, which includes a terminal and a network-side device, where the terminal can be configured to execute the steps of the port mapping method for sounding reference signals.

It should be noted that in this specification, the term “include”, “comprise”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to executing the functions in an order shown or discussed, but may also include executing the functions in a substantially simultaneous manner or in a reverse order, depending on the functions involved. For example, the described methods may be performed in an order different from that described, and steps may alternatively be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Certainly, the method in the foregoing embodiments may alternatively be implemented by hardware. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing implementations. These implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A port mapping method for sounding reference signals, comprising:
in a case that a number of ports for a first sounding reference signal (SRS) is 6 or 8, determining, by a terminal, a cyclic shift (CS) corresponding to each port for the first SRS and/or a comb position mapped by the each port for the first SRS; wherein
a comb structure size of the first SRS is N, and N is 2, 4, 6, or 8.

2. The port mapping method for sounding reference signals according to claim 1, wherein the CS corresponding to the each port for the first SRS is determined based on at least one of a cyclic shift offset value, a maximum cyclic shift offset value, a first parameter, a comb structure size, a port number, or the number of ports; and/or a comb position mapped by the each port for the first SRS is determined based on at least one of a comb offset value, the comb structure size, the cyclic shift offset value, the maximum cyclic shift offset value, the first parameter, or the port number.

3. The port mapping method for sounding reference signals according to claim 2, wherein in a case that the number of ports is 8 and the comb structure size is 2, different ports for the first SRS correspond to different CSs, and the CS corresponding to the each port for the first SRS is obtained through calculation by using the following formula:
$${n}_{SRS}^{cs , i} = [ {n}_{SRS}^{c s} + \frac{{n}_{SRS}^{cs , max} ( {p}_{i} - 1000 )}{{N}_{a p}^{SRS}} ] mod {n}_{SRS}^{cs , max} ,$$
wherein,
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, and Nₐₚ^{SRS} is the number of ports.

4. The port mapping method for sounding reference signals according to claim 3, wherein the comb position mapped by the each port for the first SRS is related to the cyclic shift offset value; and for a specific cyclic shift offset value, eight ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{T C}^{( {p}_{i} )} = \{ \begin{matrix}( {\overline{k}}_{T C} + {K}_{T C} / 2 ) mod {K}_{T C} & if {n}_{S R S}^{c s} ∈ \{ {n}_{S R S}^{cs , max} / 2 , … , {n}_{S R S}^{cs , max} - 1 \} and {p}_{i} ∈ \{ 10 \; 01 , 1003 , 1005 , 1007 \} \\ {\overline{k}}_{T C} & otherwise\end{matrix}$$
$$or$$
$${k}_{T C}^{( {p}_{i} )} = \{ \begin{matrix}( {\overline{k}}_{T C} + {K}_{T C} / 2 ) mod {K}_{T C} & if {n}_{S R S}^{cs} ∈ \{ {n}_{S R S}^{cs , max} / 2 , … , {n}_{S R S}^{cs , max} - 1 \} and {p}_{i} ∈ \{ 1000 , 1002 , 1004 , 1006 \} \\ {\overline{k}}_{T C} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

5. The port mapping method for sounding reference signals according to claim 2, wherein in a case that the number of ports is 8 and the comb structure size is 4, eight ports for the first SRS are divided into four groups, ports in a same group use a same CS, and ports in different groups use different CSs; and:
the CS corresponding to the each port for the first SRS is obtained through calculation by using the following formula:
$${n}_{S R S}^{cs , i} = [ {n}_{S R S}^{c s} + \frac{{n}_{S R S}^{cs , max} \cdot ⌊ ( {p}_{i} - 1000 ) / x ⌋ \cdot x}{{N}_{a p}^{S R S}} ] mod {n}_{SRS}^{cs , max} ,$$
wherein
ness is a CS corresponding to port i, n_{SRS}^{cs} is the cyclic shift offset value, n_{SRS}^{cs,max} is the maximum cyclic shift offset value, pᵢ is the port number, Nₐₚ^{SRS} is the number of ports, and x is the first parameter, wherein x is a value agreed by default between a network-side device and the terminal and/or a value indicated by the network-side device and/or a value reported by the terminal, and x equals to 2.

6. The port mapping method for sounding reference signals according to claim 5, wherein the eight ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1003 , 1005 , 1007 \} \\ {\overline{k}}_{T C} & otherwise\end{matrix}$$
$$or$$
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1002 , 1004 , 1006 \} \\ {\overline{k}}_{T C} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

7. The port mapping method for sounding reference signals according to claim 2, wherein in a case that the number of ports is 8 and the comb structure size is 8, eight ports for the first SRS are divided into two groups, ports in a same group use a same CS, and ports in different groups use different CSs; and
the CS corresponding to the each port for the first SRS is obtained through calculation by using the following formula:
$${n}_{S R S}^{cs , i} = [ {n}_{S R S}^{c s} + \frac{{n}_{S R S}^{cs , max} \cdot ⌊ ( {p}_{i} - 1000 ) / x ⌋ \cdot x}{{N}_{a p}^{S R S}} ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, Nₐₚ^{SRS} is the number of ports, and x is the first parameter, wherein x is a value agreed by default between a network-side device and the terminal and/or a value indicated by the network-side device and/or a value reported by the terminal, and x equals to 4.

8. The port mapping method for sounding reference signals according to claim 7, wherein the eight ports for the first SRS are divided into four groups, comb positions mapped by ports in a same group are same, and ports in different groups are mapped to different comb positions; and
the comb position mapped by the each port for the first SRS is obtained through calculation by using the following formula:
$${k}_{T C}^{( {p}_{i} )} = \{ \begin{matrix}{\overline{k}}_{T C} & if {p}_{i} ∈ \{ 1000 , 1004 \} \\ ( {\overline{k}}_{T C} + 2 ) mod {K}_{T C} & if {p}_{i} ∈ \{ 1001 , 1005 \} \\ ( {\overline{k}}_{T C} + 4 ) mod {K}_{T C} & if {p}_{i} ∈ \{ 1002 , 1006 \} \\ ( {\overline{k}}_{T C} + 6 ) mod {K}_{T C} & if {p}_{i} ∈ \{ 1003 , 1007 \}\end{matrix}$$
$$or$$
$${k}_{T C}^{( {p}_{i} )} = ( {\overline{k}}_{T C} + ( 2 ( {p}_{i} - 1000 ) ) mod 4 ) mod {K}_{T C}$$
$$or$$
$${k}_{T C}^{( {p}_{i} )} = ( {\overline{k}}_{T C} + ( 8 / x \cdot ( {p}_{i} - 1000 ) ) mod x ) mod {K}_{T C} ,$$
wherein,
k_{TC}^{(p}^{ᵢ}⁾ is a comb position mapped by the port i, k̅_{TC} is the comb offset value, and K_{TC} is the comb structure size.

9. The port mapping method for sounding reference signals according to claim 2, wherein in a case that the number of ports is 6 and the comb structure size is 2, different ports for the first SRS use different CSs; and
the CS corresponding to the each port for the first SRS is obtained through calculation by using the following formula:
$${n}_{S R S}^{cs , i} = [ {n}_{S R S}^{c s} + ⌊ \frac{{n}_{S R S}^{cs , max} ( {p}_{i} - 1000 )}{{N}_{a p}^{S R S}} ⌋ ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, and Nₐₚ^{SRS} is the number of ports; wherein
six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1002 , 1003 , 1005 \} \\ {\overline{k}}_{T C} & otherwise\end{matrix} or ,$$
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1004 \} \\ {\overline{k}}_{T C} & otherwise\end{matrix} or ,$$
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1002 , 1004 \} \\ {\overline{k}}_{T C} & otherwise\end{matrix} or ,$$
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1003 , 1005 \} \\ {\overline{k}}_{T C} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

10. The port mapping method for sounding reference signals according to claim 9, wherein in a case that the comb position mapped by the each port for the first SRS is obtained through calculation by using the following formula:
$${k}_{TC}^{( {p}_{i} )} = \{ \begin{matrix}( {\overline{k}}_{T C} + {K}_{T C} / 2 ) mod {K}_{T C} & if {p}_{i} ∈ \{ 1000 , 1002 , 1003 , 1005 \} \\ {\overline{k}}_{T C} & otherwise\end{matrix} ,$$
a port for a second SRS and ports {1001, 1004} for the first SRS are mapped to a same comb position, and a cyclic shift offset value corresponding to the second SRS is equal to a value obtained by performing remainder calculation on a maximum cyclic shift offset value corresponding to the first SRS after adding 3 to a cyclic shift offset value corresponding to the first SRS;
or,
in a case that the comb position mapped by the each port for the first SRS is obtained through calculation by using the following formula:
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 01 , 1004 \} \\ {\overline{k}}_{T C} & otherwise\end{matrix} ,$$
a port for a second SRS and ports {1001, 1004} for the first SRS are mapped to a same comb position, and a cyclic shift offset value corresponding to the second SRS is equal to a value obtained by performing remainder calculation on a maximum cyclic shift offset value corresponding to the first SRS after adding 3 to a cyclic shift offset value corresponding to the first SRS.

11. The port mapping method for sounding reference signals according to claim 2, wherein in a case that the number of ports is 6 and the comb structure size is 2, different ports for the first SRS use different CSs; and
the CS corresponding to the each port for the first SRS is obtained through calculation by using the following formula:
$${n}_{S R S}^{cs , i} = [ {n}_{S R S}^{c s} + ⌈ \frac{{n}_{S R S}^{cs , max} ( {p}_{i} - 1000 )}{{N}_{a p}^{S R S}} ⌉ ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the SRS is the number of ports; maximum cyclic shift offset value, pᵢ is the port number, and Nₐₚ^{SRS} is the number of ports; wherein
six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1000 , 1001 , 1003 , 1004 \} \\ {\overline{k}}_{T C} & otherwise\end{matrix} or ,$$
$${k}_{T C}^{( {p}_{i} )} ) = \{ \begin{matrix}( {\overline{k}}_{T C} + {K}_{T C} / 2 ) mod {K}_{T C} & if {p}_{i} ∈ \{ 10 \; 02 , 1005 \} \\ {\overline{k}}_{T C} & otherwise\end{matrix} or ,$$
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 00 , 1002 , 1004 \} \\ {\overline{k}}_{T C} & otherwise\end{matrix} or ,$$
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 1001 , 1003 , 1005 \} \\ {\overline{k}}_{T C} & otherwise\end{matrix} ,$$
wherein
k_{TC}^{(p}^{ᵢ}⁾ is a comb position mapped by the port i, k̅_{TC} is the comb offset value, and K_{TC} is the comb structure size; wherein
in a case that the comb position mapped by the each port for the first SRS is obtained through calculation by using the following formula:
$${k}_{T c}^{( {p}_{i} )} = \{ \begin{matrix}( {\overline{k}}_{T C} + {K}_{T C} / 2 ) mod {K}_{T C} & if {p}_{i} ∈ \{ 1000 , 10 \; 01 , 1003 , 1004 \} \\ {\overline{k}}_{T C} & otherwise\end{matrix} ,$$
a port for a third SRS and ports {1002, 1005} for the first SRS are mapped to a same comb position, and a cyclic shift offset value corresponding to the third SRS is equal to a value obtained by performing remainder calculation on a maximum cyclic shift offset value corresponding to the first SRS after adding 1 to a cyclic shift offset value corresponding to the first SRS;
or,
in a case that the comb position mapped by the each port for the first SRS is obtained through calculation by using the following formula:
$${k}_{T C}^{( {p}_{i} )} = \{ \begin{matrix}( {\overline{k}}_{T C} + {K}_{T C} / 2 ) mod {K}_{T C} & if {p}_{i} ∈ \{ 10 \; 02 , 1005 \} \\ {\overline{k}}_{T C} & otherwise\end{matrix}$$
a port for a third SRS and ports {1002, 1005} for the first SRS are mapped to a same comb position, and a cyclic shift offset value corresponding to the third SRS is equal to a value obtained by performing remainder calculation on a maximum cyclic shift offset value corresponding to the first SRS after adding 1 to a cyclic shift offset value corresponding to the first SRS.

12. The port mapping method for sounding reference signals according to claim 2, wherein in a case that the number of ports is 6 and the comb structure size is 2, different ports for the first SRS use different CSs; and
the CS corresponding to the each port for the first SRS is obtained through calculation by using the following formula:
$${n}_{S R S}^{cs , i} = \{ \begin{matrix}[ {n}_{S R S}^{c s} + ⌊ \frac{{n}_{S R S}^{cs , max} ( {p}_{i} - 1000 )}{{N}_{a p}^{S R S}} ⌋ ] mod {n}_{S R S}^{cs , max} if {p}_{i} ∈ \{ 10 \; 01 , 1004 \} \\ [ {n}_{S R S}^{c s} + ⌈ \frac{{n}_{S R S}^{cs , max} ( {p}_{i} - 1000 )}{{N}_{a p}^{S R S}} ⌉ ] mod {n}_{S R S}^{cs , max} if {p}_{i} ∈ \{ 10 \; 02 , 1005 \} , wherein \\ [ {n}_{S R S}^{cs} + \frac{{n}_{S R S}^{cs , max} ( {p}_{i} - 1000 )}{{N}_{a p}^{S R S}} ] mod {n}_{S R S}^{cs , max} otherwise\end{matrix}$$
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, and Nₐₚ^{SRS} is the number of ports; wherein
six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & if {p}_{i} ∈ \{ 10001 , 1002 , 1004 , 1005 \} \\ {\overline{k}}_{TC} & otherwise\end{matrix} \\ or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1003 \} \\ {\overline{k}}_{TC} & otherwise\end{matrix} \\ or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix} \\ or , {k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$
wherein
k_{TC}^{(p}^{ᵢ}⁾ is a comb position mapped by the port i, k̅_{TC} is the comb offset value, and K_{TC} is the comb structure size; wherein
in a case that the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1002 , 1004 , 1005 \} \\ {\overline{k}}_{TC} & otherwise\end{matrix} ,$$
a port for a fourth SRS and ports {1000, 1003} for the first SRS are mapped to a same comb position, and a cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS;
or,
in a case that the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1003 \} \\ {\overline{k}}_{TC} & otherwise\end{matrix} ,$$
a port for a fourth SRS and ports {1000, 1003} for the first SRS are mapped to a same comb position, and a cyclic shift offset value corresponding to the fourth SRS is equal to a value obtained by performing remainder calculation on a maximum cyclic shift offset value corresponding to the first SRS after adding 2 to a cyclic shift offset value corresponding to the first SRS.

13. The port mapping method for sounding reference signals according to claim 2, wherein in a case that the number of ports is 6 and the comb structure size is 2, different ports for the first SRS use different CSs; and
the CS corresponding to the each port for the first SRS is obtained through calculation by using the following formula:
$${n}_{SRS}^{cs , i} = \{ \begin{matrix}[ {n}_{SRS}^{cs} + ⌊ \frac{{n}_{SRS}^{cs , max} ( {p}_{i} - 1000 )}{{N}_{ap}^{SRS}} ⌋ ] mod {n}_{SRS}^{cs , max} if {p}_{i} ∈ \{ 1001 \} \\ \begin{matrix}[ {n}_{SRS}^{cs} + ⌈ \frac{{n}_{SRS}^{cs , max} ( {p}_{i} - 1000 )}{{N}_{ap}^{SRS}} ⌉ ] mod {n}_{SRS}^{cs , max} if \\ {p}_{i} ∈ \{ 1002 , 1004 , 1005 \} , wherein\end{matrix} \\ [ {n}_{SRS}^{cs} + \frac{{n}_{SRS}^{cs , max} ( {p}_{i} - 1000 )}{{N}_{ap}^{SRS}} ] mod {n}_{SRS}^{cs , max} otherwise\end{matrix}$$
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, and Nₐₚ^{SRS} is the number of ports; wherein
six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix} \\ or \\ {k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

14. The port mapping method for sounding reference signals according to claim 2, wherein in a case that the number of ports is 6 and the comb structure size is 4, different ports for the first SRS use different CSs; and
the CS corresponding to the each port for the first SRS is obtained through calculation by using the following formula:
$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, and Nₐₚ^{SRS} is the number of ports; wherein
the comb position mapped by the each port for the first SRS is related to the cyclic shift offset value; and for a specific cyclic shift offset value, six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1003 , 1005 \}\end{matrix} \\ {\overline{k}}_{TC} & otherwise\end{matrix} \\ or \\ {k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1000 , 1002 , 1004 \}\end{matrix} \\ {\overline{k}}_{TC} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

15. The port mapping method for sounding reference signals according to claim 2, wherein in a case that the number of ports is 6 and the comb structure size is 6, six ports for the first SRS are divided into two groups, ports in a same group use a same CS, and ports in different groups use different CSs; and
the CS corresponding to the each port for the first SRS is obtained through calculation by using the following formula:
$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, Nₐₚ^{SRS} is the number of ports, and x is the first parameter, wherein x is a value agreed by default between a network-side device and the terminal and/or a value indicated by the network-side device and/or a value reported by the terminal, and x equals to 3; wherein
the six ports for the first SRS are divided into three groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix} \\ or \\ {k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 1004 \} \\ ( {\overline{k}}_{TC} + {n}_{3} ) mod {K}_{TC} & if {p}_{i} ∈ \{ 1002 , 1005 \}\end{matrix} ,$$
wherein
k_{TC}^{(p}^{ᵢ}⁾ is a comb position mapped by the port i, k̅_{TC} is the comb offset value, K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

16. The port mapping method for sounding reference signals according to claim 2, wherein in a case that the number of ports is 6 and the comb structure size is 8, different ports for the first SRS use different CSs; and
the CS corresponding to the each port for the first SRS is obtained through calculation by using the following formula:
$${n}_{SRS}^{cs , i} = [ {n}_{SRS}^{cs} + \frac{{n}_{SRS}^{cs , max} ( {p}_{i} - 1000 )}{{N}_{ap}^{SRS}} ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, and Nₐₚ^{SRS} is the number of ports; wherein
the comb position mapped by the each port for the first SRS is related to the cyclic shift offset value; and for a specific cyclic shift offset value, six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1001 , 1003 , 1005 \}\end{matrix} \\ {\overline{k}}_{TC} & otherwise\end{matrix} \\ or \\ {k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ {n}_{SRS}^{cs , max} / 2 , … , {n}_{SRS}^{cs , max} - 1 \} and \\ {p}_{i} ∈ \{ 1000 , 1002 , 1004 \}\end{matrix} \\ {\overline{k}}_{TC} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

17. The port mapping method for sounding reference signals according to claim 2, wherein in a case that the number of ports is 6 and the comb structure size is 8, six ports for the first SRS are divided into three groups, ports in a same group use a same CS, and ports in different groups use different CSs; and
the CS corresponding to the each port for the first SRS is obtained through calculation by using the following formula:
$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$
wherein
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, Nₐₚ^{SRS} is the number of ports, and x is the first parameter, wherein x is a value agreed by default between a network-side device and the terminal and/or a value indicated by the network-side device and/or a value reported by the terminal, and x equals to 2; wherein
the six ports for the first SRS are divided into two groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}( {\overline{k}}_{TC} + {K}_{TC} / 2 ) mod {K}_{TC} & if {p}_{i} ∈ \{ 1001 , 1003 , 1005 \} \\ {\overline{k}}_{TC} & otherwise\end{matrix} \\ or \\ {k}_{TC}^{( {p}_{i} )} = \{ \begin{matrix}( {\overline{k}}_{TC} + {K}_{TC} / 2 ) mod {K}_{TC} & if {p}_{i} ∈ \{ 1000 , 1002 , 1004 \} \\ {\overline{k}}_{TC} & otherwise\end{matrix} ,$$
wherein
k_{TC}^{(p}^{ᵢ}⁾ is a comb position mapped by the port i, k̅_{TC} is the comb offset value, and K_{TC} is the comb structure size.

18. The port mapping method for sounding reference signals according to claim 2, wherein in a case that the number of ports is 6 and the comb structure size is 8, six ports for the first SRS are divided into two groups, ports in a same group use a same CS, and ports in different groups use different CSs; and
a CS of a sequence mapped by the each port for the first SRS is obtained through calculation by using the following formula:
$${n}_{SRS}^{cs , i} = [ {n}_{SRS}^{cs} + \frac{{n}_{SRS}^{cs , max} \cdot ⌊ ( {p}_{i} - 1000 ) / x ⌋ \cdot x}{{N}_{ap}^{SRS}} ] mod {n}_{SRS}^{cs , max} ,$$
wherein,
n_{SRS}^{cs,i} is a CS corresponding to port i, n_{SRS}^{cs} is the cyclic shift offset value, n_{SRS}^{cs,max} is the maximum cyclic shift offset value, pᵢ is the port number, Nₐₚ^{SRS} is the number of ports, and x is the first parameter, wherein x is a value agreed by default between a network-side device and the terminal and/or a value indicated by the network-side device and/or a value reported by the terminal, and x equals to 3; wherein
the six ports for the first SRS are divided into three groups, comb positions mapped by ports in a same group are same, and ports in different groups are mapped to different comb positions; and
the comb position mapped by the each port for the first SRS is obtained through calculation by using the following formula:
$${k}_{TC}^{( {p}_{i} )} = \{ \begin{matrix}{\overline{k}}_{TC} & if {p}_{i} ∈ \{ 1000 , 1003 \} \\ ( {\overline{k}}_{TC} + {n}_{1} ) mod {K}_{TC} & if {p}_{i} ∈ \{ 1001 , 1004 \} \\ ( {\overline{k}}_{TC} + {n}_{2} ) mod {K}_{TC} & if {p}_{i} ∈ \{ 1002 , 1005 \}\end{matrix} \\ or \\ {k}_{TC}^{( {p}_{i} )} = \{ \begin{matrix}( {\overline{k}}_{TC} + {n}_{1} ) mod {K}_{TC} & if {p}_{i} ∈ \{ 1000 , 1003 \} \\ ( {\overline{k}}_{TC} + {n}_{2} ) mod {K}_{TC} & if {p}_{i} ∈ \{ 1001 , 1004 \} \\ ( {\overline{k}}_{TC} + {n}_{3} ) mod {K}_{TC} & if {p}_{i} ∈ \{ 1002 , 1005 \}\end{matrix} ,$$
wherein
k_{TC}^{(p}^{ᵢ}⁾ is a comb position mapped by the port i, k̅_{TC} is the comb offset value, and K_{TC} is the comb structure size, n₁ is a value agreed by default between the network-side device and the terminal and/or a value indicated by the network-side device and/or a value reported by the terminal, n₂ is a value agreed by default between the network-side device and the terminal and/or a value indicated by the network-side device and/or a value reported by the terminal, and n₃ is a value agreed by default between the network-side device and the terminal and/or a value indicated by the network-side device and/or a value reported by the terminal.

19. A terminal, comprising a processor and a memory, wherein a program or instructions are stored in the memory and executable on the processor, and the program or the instructions, when executed by the processor, cause the terminal to perform:
in a case that a number of ports for a first sounding reference signal (SRS) is 6 or 8, determining a cyclic shift (CS) corresponding to each port for the first SRS and/or a comb position mapped by the each port for the first SRS; wherein
a comb structure size of the first SRS is N, and N is 2, 4, 6, or 8.

20. A non-transitory readable storage medium, wherein the non-transitory readable storage medium stores a program or instructions, and the program or the instructions, when executed by a processor of a terminal, cause the terminal to perform:
in a case that a number of ports for a first sounding reference signal (SRS) is 6 or 8, determining a cyclic shift (CS) corresponding to each port for the first SRS and/or a comb position mapped by the each port for the first SRS; wherein
a comb structure size of the first SRS is N, and N is 2, 4, 6, or 8.
